(19) United States
(12) Patent Application Publication
(10) Pub. No.: US 2022/0073367 A1
(43) Pub. Date: Mar. 10, 2022

(54) METHOD FOR MANUFACTURING SECONDARY BATTERY AND SECONDARY BATTERY

(71) Applicant: SEMICONDUCTOR ENERGY LABORATORY CO., LTD., ATSUGI-SHI (JP)

(72) Inventors: Yohei MOMMA, Isehara (JP); Mayumi MIKAMI, Atsugi (JP); Yusuke YOSHITANI, Isehara (JP); Kazuki TANEMURA, Isehara (JP)

(21) Appl. No.: 17/464,205

(22) Filed: Sep. 1, 2021

(30) Foreign Application Priority Data
Sep. 8, 2020 (JP) 2020-150780

(51) Int. Cl. C01G 53/00; H01M 10/0525

(52) U.S. Cl. CPC C01G 53/50; C01P 2006/40; C01P 2004/80; H01M 10/0525

(57) ABSTRACT

The present invention relates to a method for manufacturing a secondary battery and a secondary battery. A method for manufacturing a positive electrode active material with high charge and discharge capacity is provided. A method for manufacturing a positive electrode active material with high charging and discharging voltages is provided. A method for manufacturing a positive electrode active material with little deterioration is provided. The positive electrode active material is manufactured through a step of forming a composite oxide that contains lithium, nickel, manganese, cobalt, and oxygen; and a step of mixing the composite oxide and a calcium compound, and then heating the mixture at a temperature higher than or equal to 500° C. and lower than or equal to 1100° C. for 2 hours to 20 hours. By the heating, calcium is distributed at a preferred concentration in a surface portion of the positive electrode active material.

### BACKGROUND OF THE INVENTION

### 1. Field of the Invention

One embodiment of the present invention relates to an object or a manufacturing method. The present invention relates to a process, a machine, manufacture, or a composition of matter. One embodiment of the present invention relates to a power storage device such as a secondary battery, a semiconductor device, a display device, a light-emitting device, a lighting device, an electronic device, or a manufacturing method thereof.

Note that a power storage device in this specification refers to every element and device having a function of storing electric power. For example, a storage battery (also referred to as secondary battery) such as a lithium-ion secondary battery, a lithium-ion capacitor, and an electric double layer capacitor are included in the category of the power storage device.

Note that electronic devices in this specification mean all devices including power storage devices, and electro-optical devices including power storage devices, information terminal devices including power storage devices, and the like are all electronic devices.

### 2. Description of the Related Art

In recent years, a variety of power storage devices such as lithium-ion secondary batteries, lithium-ion capacitors, air batteries, and all-solid-state batteries have been actively developed. In particular, demand for lithium-ion secondary batteries with high output and high capacity has rapidly grown with the development of the semiconductor industry. The lithium-ion secondary batteries are essential as rechargeable energy supply sources for today's information society.

Thus, improvement of a positive electrode active material has been studied to increase the cycle performance and the capacity of the lithium ion secondary battery (e.g., Patent Document 1).

### REFERENCE

### Patent Document

### [Patent Document 1] Japanese Translation of PCT International Application No. 2014-531718

### SUMMARY OF THE INVENTION

Improvements of lithium-ion secondary batteries and positive electrode active materials used therein are desired in terms of capacity, cycle performance, charge and discharge characteristics, reliability, safety, cost, and the like.

In view of the above, an object of one embodiment of the present invention is to provide a positive electrode active material with little deterioration. Another object of one embodiment of the present invention is to provide a secondary battery with little deterioration. Another object of one embodiment of the present invention is to provide a secondary battery with a high degree of safety.

Another object of one embodiment of the present invention is to provide a positive electrode active material, a power storage device, or a manufacturing method thereof.

Note that the description of these objects does not preclude the existence of other objects. In one embodiment of the present invention, there is no need to achieve all these objects. Other objects can be derived from the description of the specification, the drawings, and the claims.

One embodiment of the present invention is a method for manufacturing a secondary battery, including steps of: forming a composite oxide containing lithium, nickel, manganese, cobalt, and oxygen; and mixing the composite oxide and a calcium compound, and then performing heating at a temperature higher than or equal to 500° C. and lower than or equal to 1100° C. for a time longer than or equal to 2 hours and shorter than or equal to 20 hours.

In the above embodiment, the calcium compound is preferably calcium carbonate or calcium fluoride.

In the above embodiment, when the sum of the number of atoms of nickel, manganese, and cobalt included in the composite oxide is 100, the number of atoms of nickel is preferably greater than or equal to 50.

Another embodiment of the present invention is a secondary battery including a positive electrode. The positive electrode includes a positive electrode active material. The positive electrode active material includes lithium, nickel, manganese, cobalt, oxygen, and an additive element. The additive element is one or more selected from calcium, fluorine, sodium, iron, arsenic, sulfur, and copper. The positive electrode active material includes a surface portion and an inner portion. The concentration of one or more selected from the additive element(s) is higher in the surface portion than in the inner portion.

In the above embodiment, it is preferred that the positive electrode active material include a plurality of primary particles and a secondary particle in which the plurality of primary particles adhere to each other, and that the concentration of one or more selected from the additive element(s) be higher in a surface portion of the primary particles than in the inner portion.

In the above embodiment, the additive element is preferably calcium or fluorine.

According to one embodiment of the present invention, a positive electrode active material with little deterioration can be provided. A secondary battery with little deterioration can be provided. A secondary battery with a high degree of safety can be provided.

According to one embodiment of the present invention, a positive electrode active material, a power storage device, or a manufacturing method thereof can be provided.

Note that the description of these effects does not preclude the existence of other effects. One embodiment of the present invention does not necessarily have all the effects listed above. Other effects will be apparent from and can be derived from the description of the specification, the drawings, the claims, and the like.

### BRIEF DESCRIPTION OF THE DRAWINGS

In the accompanying drawings:

FIG. 1 illustrates an example of a method for manufacturing a positive electrode active material;

FIG. 2 illustrates an example of a method for manufacturing a positive electrode active material;

FIGS. 3A and 3B illustrate an example of a positive electrode active material;

FIGS. 4A to 4D illustrate examples of a positive electrode active material;

FIG. 5 is an example of a TEM image showing crystal orientations are substantially aligned with each other;

FIG. 6A is an example of a STEM image showing crystal orientations are substantially aligned with each other, FIG. 6B shows an FFT pattern of a region of a rock-salt crystal RS, and FIG. 6C shows an FFT pattern of a region of a layered rock-salt crystal LRS;

FIG. 7 is a cross-sectional view illustrating an example of a positive electrode of a secondary battery;

FIG. 8A is an exploded perspective view of a coin-type secondary battery, FIG. 8B is a perspective view of a coin-type secondary battery, and FIG. 8C is a cross-sectional perspective view of a coin-type secondary battery;

FIG. 9A illustrates an example of a cylindrical secondary battery, FIG. 9B illustrates an example of a cylindrical secondary battery, FIG. 9C illustrates an example of a plurality of cylindrical secondary batteries, and FIG. 9D illustrates an example of a power storage system including a plurality of cylindrical secondary batteries;

FIGS. 10A and 10B illustrate examples of a secondary battery, and FIG. 10C illustrates the internal state of a secondary battery;

FIGS. 11A to 11C illustrate an example of a secondary battery;

FIGS. 12A and 12B each illustrate the appearance of a secondary battery;

FIGS. 13A to 13C illustrate a method for manufacturing a secondary battery;

FIGS. 14A to 14C illustrate structure examples of a power storage device;

FIGS. 15A and 15B illustrate examples of a secondary battery;

FIGS. 16A to 16C illustrate an example of a secondary battery;

FIGS. 17A and 17B illustrate an example of a secondary battery;

FIG. 18A is a perspective view of a power storage device, FIG. 18B is a block diagram of a power storage device, and FIG. 18C is a block diagram of a vehicle including a motor;

FIGS. 19A to 19D illustrate examples of transport vehicles;

FIGS. 20A and 20B each illustrate a power storage device;

FIG. 21A illustrates an electric bicycle, FIG. 21B illustrates a secondary battery of an electric bicycle, and FIG. 21C illustrates an electric motorcycle;

FIGS. 22A to 22D illustrate examples of electronic devices;

FIG. 23A illustrates examples of wearable devices, FIG. 23B is a perspective view of a watch-type device, FIG. 23C illustrates a side surface of a watch-type device, and FIG. 23D illustrates an example of wireless earphones;

FIGS. 24A to 24C are graphs showing charge and discharge cycle performance of positive electrode active materials in Example 1;

FIGS. 25A to 25C are graphs showing charge and discharge cycle performance of positive electrode active materials in Example 1;

FIGS. 26A to 26C are graphs showing charge and discharge cycle performance of positive electrode active materials in Example 1;

FIGS. 27A to 27C are graphs showing charge and discharge cycle performance of positive electrode active materials in Example 1;

FIGS. 28A and 28B are graphs showing the discharge capacity retention rate and maximum discharge capacity of positive electrode active materials in Example 1;

FIG. 29 is a graph showing the discharge capacity retention rate and maximum discharge capacity of positive electrode active materials in Example 1;

FIGS. 30A and 30B are graphs showing charge and discharge cycle performance of positive electrode active materials in Example 1; and

FIGS. 31A and 31B are graphs showing charge and discharge cycle performance of positive electrode active materials in Example 1.

### DETAILED DESCRIPTION OF THE INVENTION

Hereinafter, embodiments of the present invention will be described in detail with reference to the drawings. Note that the present invention is not limited to the description below, and it is easily understood by those skilled in the art that modes and details of the present invention can be modified in various ways. In addition, the present invention should not be construed as being limited to the description in the following embodiments.

A secondary battery includes a positive electrode and a negative electrode, for example. A positive electrode active material is a material included in the positive electrode. The positive electrode active material is a substance that performs a reaction contributing to the charge and discharge capacity, for example. Note that the positive electrode active material may partly contain a substance that does not contribute to the charge and discharge capacity.

In this specification and the like, the positive electrode active material of one embodiment of the present invention is expressed as a positive electrode material, a secondary battery positive electrode material, a composite oxide, or the like in some cases. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a complex.

In this specification, the term “crack” refers to not only a crack caused in the manufacturing process of a positive electrode active material, but also a crack caused by application of pressure, charge and discharge, and the like after the manufacturing process.

In this specification and the like, a surface portion of a particle of an active material and the like is, for example, a region of 50 nm or less, preferably 35 nm or less, further preferably 20 nm or less, still further preferably 10 nm or less in depth from the surface toward an inner portion. A plane caused by a crack can be regarded as a surface. A region at a position deeper than the surface portion is referred to as an inner portion.

In this specification and the like, the term “defect” refers to a crystal defect or a lattice defect. Defects include a point defect, a dislocation, a stacking fault, which is a planar defect, and a void, which is a three-dimensional defect.

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape.

In this specification and the like, a space group is represented using the short symbol of the international notation (or the Hermann-Mauguin notation). The Miller index is used to express crystal planes and orientations. An individual plane that shows a crystal plane is denoted by “( )”. A direction is denoted by “[ ]”. A reciprocal lattice point is represented using a similar index without parentheses or brackets. In the crystallography, a bar is placed over a number in the expression of crystal planes, orientations, and space groups; in this specification and the like, because of application format limitations, crystal planes, orientations, and space groups are sometimes expressed by placing a minus sign (−) in front of a number instead of placing a bar over the number.

The discharge rate refers to the relative ratio of a discharging current to the battery capacity and is expressed in a unit C. A current corresponding to 1 C in a battery with a rated capacity X Ah is XA. The case where discharging is performed at a current of 2X A is rephrased as follows: discharging is performed at 2 C. The case where discharging is performed at a current of X/5 A is rephrased as follows: discharging is performed at 0.2 C. Similarly, the case where charging is performed at a current of 2X A is rephrased as follows: charging is performed at 2 C. The case where charging is performed at a current of X/5 A is rephrased as follows: charging is performed at 0.2 C.

Constant-current charging refers to, for example, a method of performing charging at a constant charge rate. Constant-voltage charging refers to, for example, a method of performing charging with a voltage that is set constant when the voltage reaches the upper limit. Constant-current discharging refers to, for example, a method of performing discharging at a constant discharge rate.

In this specification and the like, an approximate value of a given value A refers to a value greater than or equal to 0.9×A and less than or equal to 1.1×A.

In this specification and the like, an example in which a lithium metal is used for a counter electrode in a secondary battery using a positive electrode and a positive electrode active material of one embodiment of the present invention is described in some cases; however, the secondary battery of one embodiment of the present invention is not limited to this example. Another material such as graphite or lithium titanate may be used for a negative electrode, for example. The properties of the positive electrode and the positive electrode active material of one embodiment of the present invention, such as a crystal structure unlikely to be broken by repeated charging and discharging and excellent cycle performance, are not affected by the material of the negative electrode. An example where the secondary battery of one embodiment of the present invention using a counter electrode of lithium is charged and discharged at a charging voltage of approximately 4.7 V, which is higher than a typical charging voltage, will be described; however, charging and discharging may be performed at a lower voltage. Charging and discharging at a lower voltage will result in cycle performance better than that described in this specification and the like.

In this specification and the like, a charging voltage and a discharging voltage are voltages in the case of using a counter electrode of lithium, unless otherwise specified. Note that even when the same positive electrode is used, the charging and discharging voltages of a secondary battery vary depending on the material used for the negative electrode. For example, the potential of graphite is approximately 0.1 V (vs Li/Li⁺); hence, the charging and discharging voltages in the case of using a negative electrode of graphite are lower than those in the case of using a counter electrode of lithium by approximately 0.1 V. In this specification, even in the case where the charging voltage of a secondary battery is, for example, 4.7 V or higher, the plateau region of the discharging voltage does not need to be 4.7 V or higher.

### Embodiment 1

In this embodiment, an example of a method for manufacturing a positive electrode active material of one embodiment of the present invention will be described.

A way of adding an additive element is important in manufacturing a positive electrode active material 100 having a distribution of the additive element, a composition, and/or a crystal structure that will be described in Embodiment 2. Favorable crystallinity of an inner portion 101b is also important.

Thus, in the process of manufacturing the positive electrode active material 100, it is preferred that a composite oxide containing lithium and a transition metal M, for example, lithium nickel-cobalt-manganese oxide be synthesized first, and then an additive element source be mixed and heat treatment be performed.

In a method of synthesizing a composite oxide containing an additive element, lithium, and the transition metal M by mixing an additive element source concurrently with a transition metal M source and a lithium source, it is sometimes difficult to increase the concentration of the additive element in a surface portion 101a. In addition, after a composite oxide containing lithium and the transition metal M is synthesized, only mixing an additive element source without performing heating causes the additive element to be just attached to, not dissolved in, the composite oxide containing lithium and the transition metal M It is difficult to distribute the additive element favorably without sufficient heating. Therefore, it is preferable that a composite oxide containing lithium and the transition metal M be synthesized, and then an additive element source be mixed and heat treatment be performed. The heat treatment after mixing of the additive element source may be referred to as annealing.

However, if the annealing temperature is too high, a possibility that cation mixing occurs so that lithium enters the transition metal M site or the transition metal M enters the lithium site increases. This leads to a decrease in discharge capacity, and thus is not preferable. Furthermore, adverse effects such as reduction of the transition metal M to the divalent state and evaporation of lithium are concerned.

In view of the above, a material functioning as a flux is preferably mixed together with the additive element source. The material can be regarded as functioning as a flux when having a melting point lower than that of the composite oxide containing lithium and the transition metal M For example, a fluorine compound such as lithium fluoride is preferably used. Adding the flux decreases the melting points of the additive element source and the composite oxide containing lithium and the transition metal M The decrease in melting points makes it easier to distribute the additive element favorably at a temperature at which cation mixing is less likely to occur.

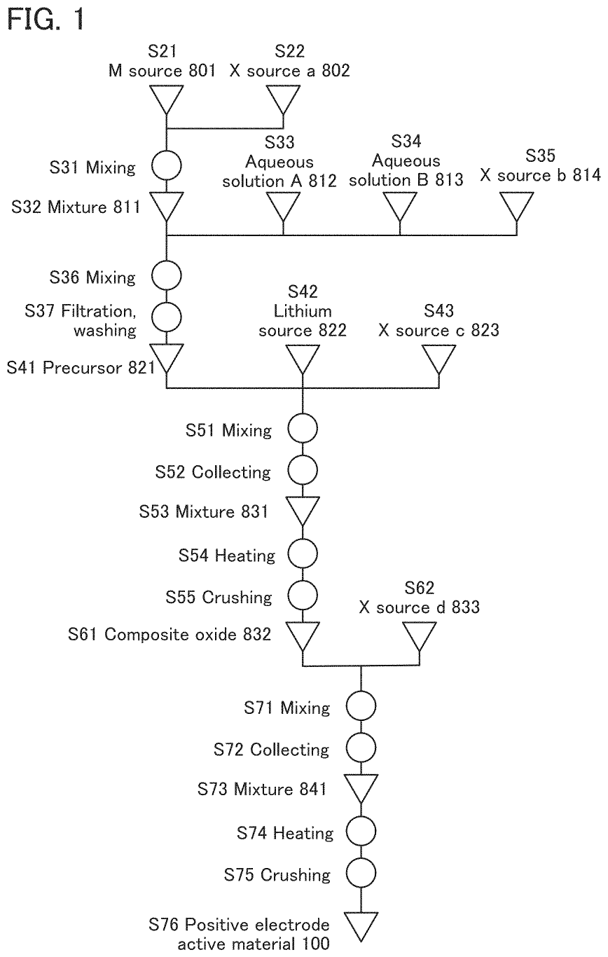

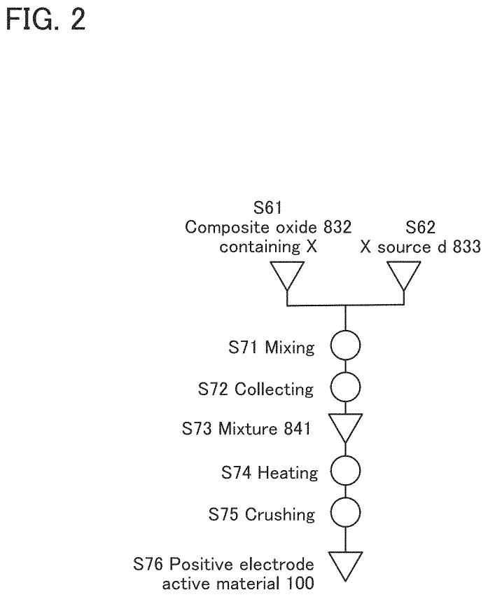

Examples of a manufacturing method including the above annealing will be described with reference to FIG. 1 and FIG. 2.

First, a transition metal M source 801 is prepared in Step S21 in FIG. 1.

As the transition metal M, one or more selected from manganese, cobalt, and nickel can be used, for example. The transition metal(s) M can be, for example, only cobalt, only nickel, cobalt and manganese, cobalt and nickel, or cobalt, manganese, and nickel.

In the case of using one or more selected from manganese, cobalt, and nickel, the mixture ratio is preferably in a range with which a layered rock-salt crystal structure is obtained.

It is preferred that the proportion of nickel in the transition metals M be high, in which case a positive electrode active material with high capacity can be formed at low cost. For example, given that the sum of the number of atoms of nickel, manganese, and cobalt contained in the positive electrode active material 100 is 100, the number of nickel atoms is preferably greater than or equal to 33, further preferably greater than or equal to 50, still further preferably greater than or equal to 80. However, when the proportion of nickel is too high, the chemical stability and heat resistance might decrease. For this reason, given that the sum of the number of atoms of nickel, manganese, and cobalt contained in the positive electrode active material is 100, the number of nickel atoms is preferably less than or equal to 95.

Manganese is preferably contained as the transition metal M, in which case the heat resistance and chemical stability are improved. However, a too high proportion of manganese tends to decrease the discharging voltage and discharge capacity. For this reason, for example, given that the sum of the number of atoms of nickel, manganese, and cobalt contained in the positive electrode active material is 100, the number of manganese atoms is preferably greater than or equal to 2.5 and less than or equal to 33.

Cobalt is preferably contained as the transition metal M, in which case the average discharging voltage is high and a secondary battery can be highly reliable because cobalt contributes to stabilization of a layered rock-salt structure. Meanwhile, the price of cobalt is higher and more unstable than those of nickel and manganese; thus, a too high proportion of cobalt might increase the cost for manufacturing the secondary battery. For this reason, for example, given that the sum of the number of atoms of nickel, manganese, and cobalt contained in the positive electrode active material 100 is 100, the number of cobalt atoms is preferably greater than or equal to 2.5 and less than or equal to 34.

As the transition metal M source 801, an aqueous solution containing the transition metal M is preferably prepared. For the transition metal M source 801, an aqueous solution of cobalt sulfate, an aqueous solution of cobalt nitrate, or the like can be used as an aqueous solution containing cobalt; an aqueous solution of nickel sulfate, an aqueous solution of nickel nitrate, or the like can be used as an aqueous solution containing nickel; and an aqueous solution of manganese sulfate, an aqueous solution of manganese nitrate, or the like can be used as an aqueous solution containing manganese.

Next, an additive element X source a 802 is preferably prepared in Step S22.

The additive element X is preferably one or more selected from alkali earth metals such as calcium and magnesium, halogen such as fluorine, sodium, iron, arsenic, sulfur, and copper. In particular, one or both of calcium and fluorine are preferably used.

Note that the additive element X can be added not only in Step S22 but also in Step S35, Step S43, or Step S62 that will be described later. The additive element X is added in at least one step selected from these steps. Accordingly, all the additive element(s) X may be added in one step, a different element may be added in each step, or the same element may be added a plurality of times. The additive element X source can be prepared in at least one step selected from Step S22, Step S35, Step S43, and Step S62 such that the additive element(s) eventually contained in the positive electrode active material 100 has a preferable proportion.

Calcium is preferably included as the additive element X source a 802, in which case the positive electrode active material 100 can have excellent charge and discharge cycle performance. Calcium, which has a larger ion radius than lithium, nickel, manganese, and cobalt, is likely to be distributed unevenly in the surface portion of the positive electrode active material 100. In addition, calcium, which is a divalent representative element, contributes to stabilization of the crystal structure of the surface portion, and thus is preferable as the additive element. By stabilization of the crystal structure of the surface portion, the effect of inhibiting dissolution of the transition metal M and release of oxygen from the positive electrode active material 100 can be expected. Furthermore, when the additive element is distributed unevenly in defects such as a grain boundary, a crack, and a void, the bonding strength can be increased. However, a too large amount of calcium might decrease the charge and discharge capacity. Thus, the proportion of calcium contained in the positive electrode active material 100 is preferably greater than or equal to 0.1 at. % and less than or equal to 2 at. %. As the calcium source, a calcium compound such as calcium fluoride, calcium carbonate, calcium oxide, calcium hydroxide, calcium chloride, calcium aluminate, calcium titanate, or calcium zirconate can be used, for example. The amount of calcium contained in the positive electrode active material 100 may be, for example, a value obtained by element analysis on the entire positive electrode active material 100 with a glow discharge mass spectrometer (GD-MS), an inductively coupled plasma mass spectrometer (ICP-MS), or the like or may be based on the proportion of a raw material in the process of manufacturing the positive electrode active material 100.

Fluorine is preferably included as the additive element X source a 802, in which case the positive electrode active material 100 can have excellent charge and discharge cycle performance. A fluoride serves as a flux that promotes diffusion of other additive elements X such as calcium. Thus, when a fluoride is included, the other additive elements X can be distributed in the surface portion at a preferred concentration. Furthermore, when fluorine, which is a monovalent anion, is substituted for part of oxygen in the surface portion, the lithium extraction energy is lowered. This is because the oxidation-reduction potential of cobalt ions associated with lithium extraction differs depending on whether fluorine exists. That is, when fluorene is not included, cobalt ions change from a trivalent state to a tetravalent state due to lithium extraction. Meanwhile, when fluorene is included, cobalt ions change from a divalent state to a trivalent state due to lithium extraction. The oxidation-reduction potential of cobalt ions differs in these cases. It can thus be said that when fluorine is substituted for part of oxygen in the surface portion of the positive electrode active material 100, lithium ions near fluorine are likely to be extracted and inserted smoothly. Consequently, using such a positive electrode active material 100 in a secondary battery is preferable, in which case the charge and discharge characteristics, rate performance, and the like are improved. However, a too large amount of fluorine might decrease the charge and discharge capacity. Hence, the proportion of fluorine contained in the positive electrode active material 100 is preferably greater than or equal to 0.0003 wt % and less than or equal to 0.1 wt %, further preferably greater than or equal to 0.01 wt % and less than or equal to 0.03 wt %. The amount of fluorine contained in the positive electrode active material 100 may be, for example, a value obtained by element analysis on the entire positive electrode active material 100 with a GD-MS, an ICP-MS, or the like or may be based on the proportion of a raw material in the process of manufacturing the positive electrode active material 100. As the fluorine source, calcium fluoride (CaF₂), lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), sodium fluoride (NaF), potassium fluoride (KF), barium fluoride (BaF₂), cerium fluoride (CeF₂), lanthanum fluoride (LaF₃), or sodium aluminum hexafluoride (Na₃AlF₆) can be used, for example. The fluorine source is not limited to a solid, and for example, fluorine (F₂), carbon fluoride, sulfur fluoride, oxygen fluoride (e.g., OF₂, O₂F₂, O₃F₂, O₄F₂, and O₂F), or the like may be used and mixed in the atmosphere in a heating step described later. Alternatively, a plurality of fluorine sources may be mixed to be used.

When sodium is included as the additive element X source a 802, sodium, which has a larger ion radius than lithium, can contribute to stabilization of a layered rock-salt crystal structure. However, a too large amount of sodium might decrease the charge and discharge capacity. Thus, the proportion of sodium contained in the positive electrode active material 100 is preferably greater than or equal to 0.003 wt % and less than or equal to 0.03 wt %. As the sodium source, sodium fluoride, sodium carbonate, sodium oxide, sodium hydroxide, or sodium chloride can be used, for example. The amount of sodium contained in the positive electrode active material 100 may be, for example, a value obtained by element analysis on the entire positive electrode active material 100 with a GD-MS, an ICP-MS, or the like or may be based on the proportion of a raw material in the process of manufacturing the positive electrode active material 100.

Iron is preferably included as the additive element X source a 802, in which case the positive electrode active material can possibly have excellent charge and discharge characteristics. In a positive electrode active material having a layered rock-salt crystal structure, the internal resistance tends to increase at the initial stage of charging of a secondary battery, that is, when extraction of lithium from the positive electrode active material starts. Thus, when the positive electrode active material 100 contains a metal that takes a tetravalent state, such as iron, lithium is easily extracted and the internal resistance at the initial stage of charging can possibly be prevented from increasing. However, a too large amount of iron might decrease the stability of the layered rock-salt crystal structure. Therefore, the proportion of iron contained in the positive electrode active material 100 is preferably greater than or equal to 0.001 wt % and less than or equal to 0.01 wt %, further preferably less than or equal to 0.004 wt %. The amount of iron contained in the positive electrode active material 100 may be, for example, a value obtained by element analysis on the entire positive electrode active material 100 with a GD-MS, an ICP-MS, or the like or may be based on the proportion of a raw material in the process of manufacturing the positive electrode active material 100. As the iron source, an iron element, iron oxide, iron hydroxide, iron alkoxide, or iron fluoride can be used, for example.

When arsenic is included as the additive element X source a 802, the positive electrode active material 100 can possibly have excellent charge and discharge characteristics. Arsenic becomes a polyanion like phosphorus, for example, and can contribute to stabilization of a crystal structure. However, a too large amount of arsenic might decrease the charge and discharge capacity. Thus, the proportion of arsenic contained in the positive electrode active material 100 is preferably greater than or equal to 0.01 wt % and less than or equal to 0.1 wt %. The amount of arsenic contained in the positive electrode active material 100 may be, for example, a value obtained by element analysis on the entire positive electrode active material 100 with a GD-MS, an ICP-MS, or the like or may be based on the proportion of a raw material in the process of manufacturing the positive electrode active material 100. As the arsenic source, an arsenic element, arsenic oxide, arsenate hydrate, or calcium arsenate can be used, for example.

When magnesium is included as the additive element X source a 802, the positive electrode active material 100 can sometimes have excellent charge and discharge characteristics as in the case of using calcium. Although magnesium is a divalent representative element, it is difficult to distribute magnesium unevenly in the surface portion of the positive electrode active material 100 in which the proportion of nickel in the transition metals M is greater than or equal to 20 at %; hence, magnesium is less likely to contribute to stabilization of the surface portion. Thus, a larger amount of magnesium tends to decrease the charge and discharge capacity. Therefore, the proportion of magnesium contained in the positive electrode active material 100 is preferably less than or equal to 0.5 wt %, further preferably less than or equal to 0.01 wt %. The amount of magnesium contained in the positive electrode active material 100 may be, for example, a value obtained by element analysis on the entire positive electrode active material 100 with a GD-MS, an ICP-MS, or the like or may be based on the proportion of a raw material in the process of manufacturing the positive electrode active material 100.

Next, in Step S31, the transition metal M source 801 and the additive element X source a 802 are mixed, whereby a mixture 811 in Step S32 is obtained.

Then, an aqueous solution A 812, an aqueous solution B 813, and an additive element X source b 814 are prepared in Step S33, Step S34, and Step S35, respectively.

As the aqueous solution A 812, one of an ammonia water and an aqueous solution containing at least one selected from chelating agents such as glycine, oxine, 1-nitroso-2-naphthol, and 2-mercaptobenzothiazole, or a mixed solution of at least two of the above can be used.

As the aqueous solution B 813, one of an aqueous solution of sodium hydroxide, an aqueous solution of potassium hydroxide, and an aqueous solution of lithium hydroxide, or a mixed solution of at least two of the above can be used.

The description of the additive element X source a 802 can be referred to for the additive element X source b 814.

Next, in Step S36, the mixture 811 in Step S32, the aqueous solution A 812, the aqueous solution B 813, and the additive element X source b 814 are mixed.

Step S36 can employ a mixing method in which the mixture 811 in Step S32, the aqueous solution B 813, and the additive element X source b 814 are dropped into the aqueous solution A 812 that is put in a reaction container. While the mixture 811 in Step S32 is dropped at a constant rate, the aqueous solution B 813 is preferably dropped as appropriate so that the pH of the mixed solution in the reaction container is kept in a predetermined range. In the mixing of Step S36, it is preferred that the solution in the reaction container be stirred with a stirring blade or a stirrer, and that dissolved oxygen in the solution in the reaction container, the mixture 811, the aqueous solution A 812, and the aqueous solution B 813 be removed by nitrogen bubbling. In the mixing of Step S36, the pH of the solution in the reaction container is preferably greater than or equal to 9 and less than or equal to 11, further preferably greater than or equal to 10.0 and less than or equal to 10.5. In the mixing of Step S36, the temperature of the solution in the reaction container is preferably higher than or equal to 40° C. and lower than or equal to 80° C., further preferably higher than or equal to 50° C. and lower than or equal to 70° C.

Alternatively, Step S36 can employ a mixing method in which the aqueous solution A 812 and the aqueous solution B 813 are dropped into the mixture 811 in Step S32 and the additive element X source b 814 that are put in a reaction container. It is preferable to adjust the dropping rates of the aqueous solution A 812 and the aqueous solution B 813 in order to keep the concentration of hydroxyl groups and the concentration of dissolved ions of the aqueous solution A 812 in the reaction container. In the mixing of Step S36, it is preferred that the solution in the reaction container be stirred with a stirring blade or a stirrer, and that dissolved oxygen in the solution in the reaction container, the mixture 811 in Step S32, the aqueous solution A 812, and the aqueous solution B 813 be removed by nitrogen bubbling. In the mixing of Step S36, the temperature of the solution in the reaction container is preferably higher than or equal to 40° C. and lower than or equal to 80° C., further preferably higher than or equal to 50° C. and lower than or equal to 70° C.

The aqueous solution A 812 is not necessarily used in Step S36. For example, a certain amount of the aqueous solution B 813 may be dropped and added to the mixture 811 in Step S32 and the additive element X source b 814 that are put in a reaction container. In the mixing of Step S36, it is preferable that the solution in the reaction container be stirred with a stirring blade or a stirrer, and that dissolved oxygen in the solution in the reaction container, the mixture 811 in Step S32, and the aqueous solution B 813 be removed by nitrogen bubbling. In the mixing of Step S36, the temperature of the solution in the reaction container is preferably higher than or equal to 40° C. and lower than or equal to 80° C., further preferably higher than or equal to 50° C. and lower than or equal to 70° C.

In Step S36, pure water may be used in addition to the mixture 811 in Step S32, the aqueous solution A 812, the aqueous solution B 813, and the additive element X source b 814. While the mixture 811 in Step S32 and the aqueous solution A 812 are dropped at a constant rate into pure water put in a reaction container, the aqueous solution B 813 can be dropped as appropriate so that the pH of the mixed solution in the reaction container is kept in a predetermined range. In the mixing of Step S36, it is preferred that the solution in the reaction container be stirred with a stirring blade or a stirrer, and that dissolved oxygen in the solution in the reaction container, the mixture 811 in Step S32, the aqueous solution A 812, and the aqueous solution B 813 be removed by nitrogen bubbling. In the mixing of Step S36, the pH of the solution in the reaction container is preferably greater than or equal to 9 and less than or equal to 11, further preferably greater than or equal to 10.0 and less than or equal to 10.5. In the mixing of Step S36, the temperature of the solution in the reaction container is preferably higher than or equal to 40° C. and lower than or equal to 80° C., further preferably higher than or equal to 50° C. and lower than or equal to 70° C.

Next, in Step S37, the solution that is formed by the mixing in Step S36 and includes the hydroxide containing the transition metal M is filtered and then washed with water. The hydroxide containing the transition metal M after the washing is dried and collected, whereby a precursor 821 in Step S41 is obtained. The water used for the washing is preferably pure water that includes few impurities and has a resistivity preferably 1M Ω·cm or higher, further preferably 10M Ω·cm or higher, still further preferably 15M Ω·cm or higher. By using pure water including few impurities for the washing, impurities included in the hydroxide containing the transition metal M can be removed, and a high-purity hydroxide containing the transition metal M can be obtained as the precursor 821. Note that a precursor in this specification and the like refers to a precursor of a composite oxide containing lithium and the transition metal M.

Next, a lithium source 822 and an additive element X source c 823 are prepared in Step S42 and Step S43, respectively. Then, in Step S51, the precursor 821 in Step S41, the lithium source 822, and the additive element X source c 823 are mixed. After the mixing, the mixture is collected in Step S52 to give a mixture 831 in Step S53. The mixing can be performed by a dry method or a wet method. For example, a ball mill or a bead mill can be used for the mixing. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. Note that in this embodiment, mixing is performed at a peripheral speed of 838 mm/s (the number of rotations: 400 rpm, the ball mill diameter: 40 mm).

As the lithium source 822, lithium hydroxide, lithium carbonate, lithium nitrate, or lithium fluoride can be used, for example. The description of the additive element X source a 802 can be referred to for the additive element X source c 823.

Next, in Step S54, the mixture 831 in Step S53 is heated. This step is sometimes referred to as baking or first heating to distinguish this step from a heating step performed later. The heating is performed at a temperature preferably higher than or equal to 600° C. and lower than 1100° C., further preferably at higher than or equal to 650° C. and lower than or equal to 950° C., still further preferably higher than or equal to 700° C. and lower than or equal to 850° C.

The heating time can be longer than or equal to 1 hour and shorter than or equal to 100 hours, for example, and is preferably longer than or equal to 2 hours and shorter than or equal to 20 hours. A shorter heating time is preferable, in which case the productivity increases. The heating is preferably performed in oxygen or an oxygen-containing atmosphere with few moisture (e.g., with a dew point lower than or equal to −50° C., preferably lower than or equal to −80° C.), such as a dry air. In this embodiment, the heating is performed in an atmosphere with a dew point of −93° C. Furthermore, it is preferable to perform the heating in an atmosphere where the concentrations of CH₄, CO, CO₂, and H₂, which are impurities, are less than or equal to 5 ppb (parts per billion), in which case impurities can be prevented from entering the materials.

For example, when the heating is performed at 850° C. for 10 hours, the temperature rising rate is preferably 200° C./h and the flow rate of a dry atmosphere is preferably 10 L/min. After that, the heated materials can be cooled to room temperature. The temperature decreasing time from the specified temperature to room temperature is preferably longer than or equal to 10 hours and shorter than or equal to 50 hours, for example. Note that the cooling to room temperature in Step S54 is not necessarily performed.

Note that a crucible used in the heating in Step S54 is preferably made of a material into which impurities do not enter. In this embodiment, a crucible made of alumina with a purity of 99.9% is used.

Then, the materials that have been heated are preferably crushed using a mortar or the like in Step S55. The mortar is preferably made of a material into which impurities do not enter. Specifically, it is preferable to use a mortar made of alumina with a purity of 90 wt % or higher, preferably 99 wt % or higher. Note that conditions equivalent to those in Step S54 can be employed in an after-mentioned heating step other than Step S54.

In the above manner, a composite oxide 832 containing lithium and the transition metal M is obtained (Step S61).

Next, in Step S62, an additive element X source d 833 is prepared.

Although the description of the additive element X source a 802 can be referred to for the additive element X source d 833, an element that preferably exists in the surface portion of the positive electrode active material 100 is particularly preferably prepared as the additive element X source d 833. For example, a calcium source and a fluorine source are preferably prepared in Step S62.

In the case where mixing and crushing steps are performed by a wet method, a solvent is also prepared. As the solvent, ketone such as acetone, alcohol such as ethanol or isopropanol, ether, dioxane, acetonitrile, N-methyl-2-pyrrolidone (NMP), or the like can be used. An aprotic solvent, which is less likely to react with lithium, is preferably used. In this embodiment, dehydrated acetone with a purity of 99.5% or higher is used.

Next, in Step S71, the composite oxide 832 in Step S61 and the additive element X source d 833 in Step S62 are mixed. After the mixing, the mixture is collected in Step S72 to give a mixture 841 in Step S73. The mixing can be performed by a dry method or a wet method. For example, a ball mill or a bead mill can be used for the mixing. When a ball mill is used, zirconia balls are preferably used as media, for example. When a ball mill, a bead mill, or the like is used, the peripheral speed is preferably greater than or equal to 100 mm/s and less than or equal to 2000 min/s in order to inhibit contamination from the media or the material. Note that in this embodiment, mixing is performed at a peripheral speed of 838 mm/s (the number of rotations: 400 rpm, the ball mill diameter: 40 mm).

Next, in Step S74, the mixture 841 in Step S73 is heated. This step can be referred to as annealing or second heating to distinguish this step from the other heating step. The temperature of the heating in Step S74 is preferably higher than or equal to 500° C. and lower than or equal to 1100° C., further preferably higher than or equal to 600° C. and lower than 900° C., still further preferably higher than or equal to 650° C. and lower than or equal to 850° C. If the annealing temperature is too high, primary particles of the positive electrode active material 100 might become too large. Too large primary particles might cause an increase in distortion in charging and discharging, leading to a crack in the positive electrode active material 100.

In Step S74, heating by a roller hearth kiln may be performed. When heat treatment is performed by a roller hearth kiln, the mixture 841 is preferably processed using a heat-resistant container having a lid.

The heating time can be longer than or equal to 1 hour and shorter than or equal to 100 hours, for example, and is preferably longer than or equal to 2 hours and shorter than or equal to 20 hours. The heating is preferably performed in oxygen or an oxygen-containing atmosphere with few moisture (e.g., with a dew point lower than or equal to −50° C., preferably lower than or equal to −80° C.), such as a dry air. In this embodiment, the heating is performed in an atmosphere with a dew point of −93° C. Furthermore, it is preferable to perform the heating in an atmosphere where the concentrations of CH₄, CO, CO₂, and H₂, which are impurities, are less than or equal to 5 ppb (parts per billion), in which case impurities can be prevented from entering the materials.

For example, when the heating is performed at 800° C. for 2 hours, the temperature rising rate is preferably 200° C./h and the flow rate of oxygen is preferably 10 L/min. After that, the heated materials can be cooled to room temperature. The temperature decreasing time from the specified temperature to room temperature is preferably longer than or equal to 10 hours and shorter than or equal to 50 hours, for example. Note that the cooling to room temperature in Step S74 is not necessarily performed.

Then, the materials baked in the above manner are crushed in Step S75, whereby the positive electrode active material 100 in Step S76 is obtained.

Next, an example of a manufacturing method different from that in FIG. 1 will be described with reference to FIG. 2. Many portions are common to FIG. 1; hence, different portions will be mainly described. The description of FIG. 1 can be referred to for the common portions.

First, in Step S61 in FIG. 2, a pre-synthesized composite oxide 832 containing lithium and the transition metal M is prepared. The composite oxide 832 preferably contains the additive element X The additive element X contained in the composite oxide 832 is preferably an element that is preferably distributed evenly in the inner portion of the positive electrode active material 100. Specifically, the composite oxide 832 preferably contains one or more selected from sodium, iron, and arsenic which are the additive elements X.

With the use of the pre-synthesized composite oxide 832, Step S21 to Step S55 in FIG. 1 can be omitted.

Next, the additive element X source d 833 is prepared in Step S62. As in Step S62 in FIG. 1, an element that preferably exists in the surface portion of the positive electrode active material 100 is preferably prepared here. For example, a calcium source and a fluorine source are preferably prepared in Step S62.

The description of FIG. 1 can be referred to for Step S71 to Step S76.

When the steps of introducing a plurality of additive elements X are separately performed in such a manner, the profiles of the elements in the depth direction can vary in some cases. For example, the concentration of a given additive element can be made higher in the surface portion than in the inner portion of the positive electrode active material 100. Furthermore, the ratio of the number of atoms of a given additive element to the number of atoms of the transition metal M can be made higher in the surface portion than in the inner portion.

This embodiment can be implemented in combination with any of the other embodiments.

### Embodiment 2

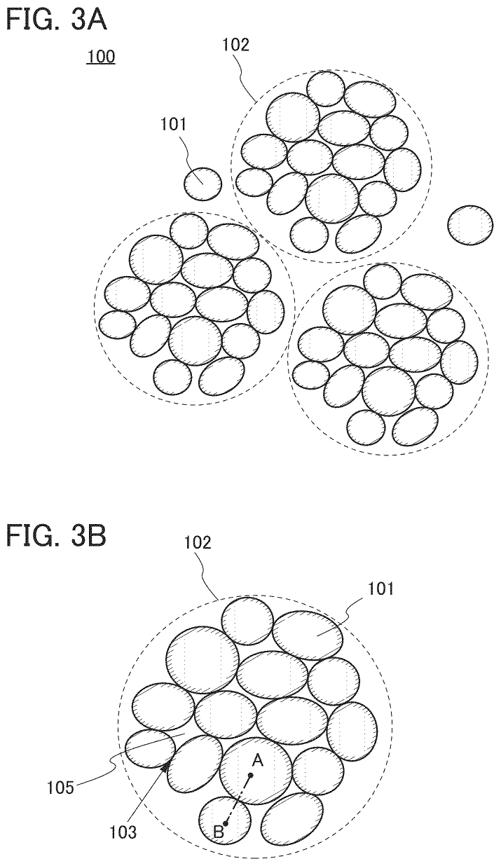

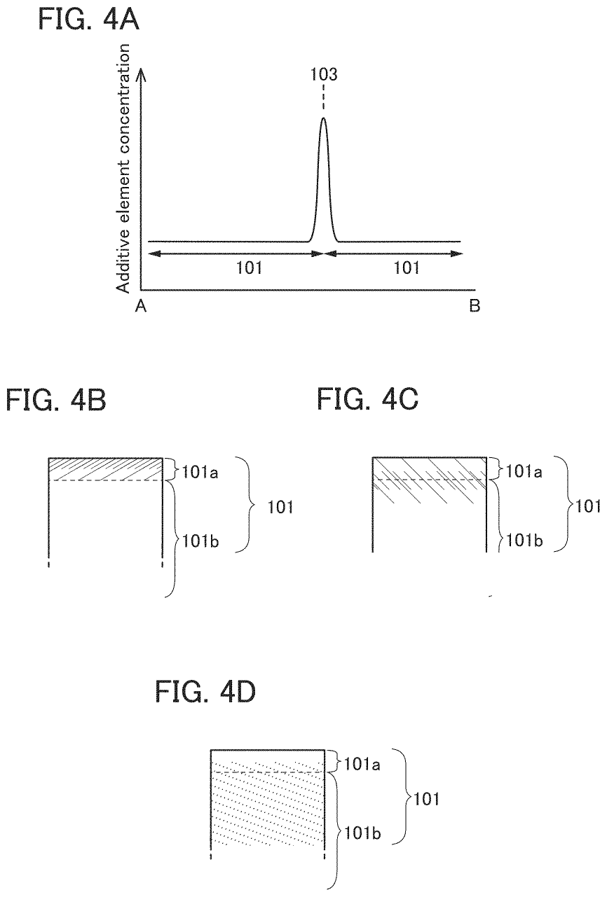

In this embodiment, the positive electrode active material 100 of one embodiment of the present invention will be described with reference to FIGS. 3A and 3B and FIGS. 4A to 4D.

FIG. 3A is a cross-sectional view of the positive electrode active material 100. The positive electrode active material 100 includes a plurality of primary particles 101. At least some of the plurality of primary particles 101 adhere to each other to form secondary particles 102. FIG. 3B is an enlarged view of the secondary particle 102. The positive electrode active material 100 may include a space 105. Note that the shapes of the primary particles 101 and the secondary particles 102 illustrated in FIGS. 3A and 3B are just examples and are not limited thereto.

In this specification and the like, a primary particle is a smallest unit that is recognizable as a solid having a clear boundary in micrographs such as a SEM image, a TEM image, and a STEM image. A secondary particle is a particle in which a plurality of primary particles adhere to each other. The term “adhere” refers to a state where particles aggregate and fix through heating. A state where particles simply aggregate and fix is regarded as “adhere to each other”, and there is no limitation on the heating temperature, the crystal state, the state of distribution of elements, and the like. In this case, there is no limitation on the bonding force acting between a plurality of primary particles. The bonding force may be one of covalent bonding, ionic bonding, a hydrophobic interaction, the Van der Waals force, and other molecular interactions, or a plurality of bonding forces may work together. In addition, the simple term “particle” includes a primary particle and a secondary particle.

### <Contained Elements>

The positive electrode active material 100 contains lithium, the transition metal M, oxygen, and the additive element X.

The positive electrode active material 100 can be regarded as a composite oxide represented by LiMO₂ to which a plurality of additives are added. Note that the positive electrode active material of one embodiment of the present invention only needs to have a crystal structure of a lithium composite oxide represented by LiMO₂, and the composition is not strictly limited to Li:M:O=1:1:2.

As the transition metal M contained in the positive electrode active material 100, a metal that can form, together with lithium, a layered rock-salt composite oxide belonging to the space group R-3m is preferably used. For example, one or more selected from manganese, cobalt, and nickel can be used. That is, as the transition metal contained in the positive electrode active material 100, only cobalt or nickel may be used, cobalt and manganese or nickel may be used, or cobalt, manganese, and nickel may be used. In other words, the positive electrode active material 100 can contain a composite oxide containing lithium and the transition metal M, such as lithium cobalt oxide, lithium nickel oxide, lithium nickel oxide in which manganese is substituted for part of nickel, lithium nickel oxide in which cobalt is substituted for part of nickel, or lithium nickel-cobalt-manganese oxide.

As the additive element X, one or more selected from calcium, fluorine, sodium, iron, arsenic, sulfur, and copper are preferably used.

The description in Embodiment 1 can be referred to for preferred proportions of the elements contained in the positive electrode active materials 100.

### <Element Distribution>

One or more of the additive elements X in the positive electrode active material 100 preferably have a concentration gradient.

For example, it is preferred that the primary particle 101 include the surface portion 101a and the inner portion 101b, and that the concentration of the additive element X be higher in the surface portion 101a than in the inner portion 101b. In FIGS. 3A and 3B, the concentration of the additive element X in the primary particle 101 is represented by a gradation. A high color density, that is, a color close to black means that the concentration of the additive element is high; a low color density, that is, a color close to white means that the concentration of the additive element is low.

The concentration of the additive element at and around an interface 103 between the primary particles is preferably higher than that in the inner portion 101b of the primary particles 101. In this specification and the like, “around the interface 103” and “the vicinity of the interface 103” refer to a region of approximately 10 nm in depth from the interface 103.

FIG. 4A shows an example of the concentration distribution of the additive element of the positive electrode active material 100 along the dashed-dotted line A-B in FIG. 3B. In FIG. 4A, the horizontal axis represents the distance between A and B in FIG. 3B, and the vertical axis represents the concentration of the additive element.

The interface 103 and the vicinity of the interface 103 include a region where the concentration of the additive element is higher than that of the primary particles 101. Note that the shape of the concentration distribution of the additive element is not limited to the shape shown in FIG. 4A.

In the case where a plurality of additive elements X are contained, the peak position of the concentration preferably differs between the additive elements.

Examples of the additive element X that preferably has a concentration gradient which increases from the inner portion 101b toward the surface as shown in FIG. 3A, FIG. 3B, and FIG. 4B include calcium and fluorine.

Another additive element X preferably has a concentration peak in the positive electrode active material 100, as illustrated in FIG. 4C, in a region closer to the inner portion 101b than the additive that is distributed as in FIG. 4B. The concentration peak may be located in the surface portion or located deeper than the surface portion. For example, the concentration peak is preferably located in a region of 5 nm to 30 nm in depth from the surface.

Still another additive element X preferably exists evenly in the inner portion 101b of the positive electrode active material 100, as illustrated in FIG. 4D. Examples of the element that is preferably distributed in such a manner include sodium, iron, arsenic, and copper.

As for some metal contained in the positive electrode active material 100 of one embodiment of the present invention, for example, manganese, the concentration in the surface portion 101a of the primary particle 101 is preferably higher than the average concentration in the entire positive electrode active material 100 or the concentration in the inner portion 101b. For example, the concentration of manganese in the surface portion 101a measured by XPS or the like is preferably higher than the average concentration of manganese in the entire positive electrode active material 100 measured with an ICP-MS or the like. Alternatively, the manganese concentration preferably has a gradient that increases from the inner portion toward the surface in line analysis such as energy dispersive X-ray spectroscopy (EDX) or an electron probe microanalyzer (EPMA).

Unlike the inner portion of a crystal, a particle surface is in a state where bonding is cut, and lithium is extracted from the surface during charging; thus, the lithium concentration in the surface tends to be lower than that in the inner portion 101b. Therefore, the surface tends to be unstable and its crystal structure is likely to be broken. The higher the concentration of the additive element in the surface portion 101a is, the more effectively the change in the crystal structure can be reduced. In addition, a high concentration of the additive element in the surface portion 101a probably increases the corrosion resistance to hydrofluoric acid generated by decomposition of the electrolyte solution.

As described above, the composition of the surface portion 101a of the positive electrode active material 100 of one embodiment of the present invention is preferably different from that of the inner portion 101b such that the concentration of the additive element in the surface portion 101a is higher than that in the inner portion 101b. Moreover, the surface portion 101a preferably has a stable crystal structure at room temperature (25° C.). Accordingly, the surface portion 101a may have a crystal structure different from that of the inner portion 101b. For example, at least part of the surface portion 101a of the positive electrode active material 100 of one embodiment of the present invention may have a rock-salt crystal structure. When the surface portion 101a and the inner portion 101b have different crystal structures, the orientations of crystals in the surface portion 101a and the inner portion 101b are preferably substantially aligned with each other.

For example, a crystal structure is preferably changed continuously from the layered rock-salt inner portion 101b toward the surface and the surface portion 101a that have a rock-salt structure or have features of both a rock-salt structure and a layered rock-salt structure. Alternatively, the orientations of the surface portion 101a that has a rock-salt structure or has the features of both a rock-salt structure and a layered rock-salt structure and the layered rock-salt inner portion 101b are preferably substantially aligned with each other.

Note that in this specification and the like, a layered rock-salt crystal structure that belongs to the space group R-3m of a composite oxide containing lithium and the transition metal M refers to a crystal structure in which a rock-salt ion arrangement where cations and anions are alternately arranged is included and lithium and the transition metal M are regularly arranged to form a two-dimensional plane, so that lithium can diffuse two-dimensionally. Note that a defect such as a cation or anion vacancy may exist. In the layered rock-salt crystal structure, strictly, a lattice of a rock-salt crystal is distorted in some cases.

A rock-salt crystal structure refers to a structure in which a cubic crystal structure with the space group Fm-3m or the like is included and cations and anions are alternately arranged. Note that a cation or anion vacancy may exist.

Having both a layered rock-salt crystal structure and a rock-salt crystal structure can be judged by electron diffraction, a TEM image, a cross-sectional STEM image, and the like.

There is no distinction among cation sites in a rock-salt structure. Meanwhile, a layered rock-salt crystal structure has two types of cation sites: one type is mostly occupied by lithium, and the other is occupied by the transition metal M. A stacked-layer structure where two-dimensional planes of cations and two-dimensional planes of anions are alternately arranged is the same in a rock-salt structure and a layered rock-salt structure. Given that the center spot (transmission spot) among bright spots in an electron diffraction pattern corresponding to crystal planes that form the two-dimensional planes is at the origin point 000, the bright spot nearest to the center spot is on the (111) plane in an ideal rock-salt structure, for instance, and on the (003) plane in a layered rock-salt structure, for instance. For example, when electron diffraction patterns of rock-salt MgO and layered rock-salt LiCoO₂ are compared to each other, the distance between the bright spots on the (003) plane of LiCoO₂ is observed at a distance approximately half the distance between the bright spots on the (111) plane of MgO. Thus, when two phases of rock-salt MgO and layered rock-salt LiCoO₂ are included in a region to be analyzed, a plane orientation in which bright spots with high luminance and bright spots with low luminance are alternately arranged exists in an electron diffraction pattern. A bright spot common between the rock-salt and layered rock-salt structures has high luminance, whereas a bright spot caused only in the layered rock-salt structure has low luminance.

When a layered rock-salt crystal structure is observed from a direction perpendicular to the c-axis in a cross-sectional STEM image and the like, layers observed with high luminance and layers observed with low luminance are alternately observed. Such a feature is not observed in a rock-salt structure because there is no distinction among cation sites. When a crystal structure having the features of both a rock-salt structure and a layered rock-salt structure is observed from a given crystal orientation, layers observed with high luminance and layers observed with low luminance are alternately observed in a cross-sectional STEM image and the like, and a metal that has a lager atomic number than lithium exists in part of the layers with low luminance, i.e., the lithium layers.

Anions of a layered rock-salt crystal and anions of a rock-salt crystal form a cubic close-packed structure (face-centered cubic lattice structure). Thus, when a layered rock-salt crystal and a rock-salt crystal are in contact with each other, there is a crystal plane at which orientations of cubic close-packed structures formed of anions are aligned with each other.

The description can also be made as follows. An anion on the {111} plane of a cubic crystal structure has a triangle lattice. A layered rock-salt structure, which belongs to a space group R-3m and is a rhombohedral structure, is generally represented by a composite hexagonal lattice for easy understanding of the structure, and the (0001) plane of the layered rock-salt structure has a hexagonal lattice. The triangle lattice on the {111} plane of the cubic crystal has atomic arrangement similar to that of the hexagonal lattice on the (0001) plane of the layered rock-salt structure. These lattices being consistent with each other can be referred to as “orientations of the cubic close-packed structures are aligned with each other”.

Note that a space group of the layered rock-salt crystal is R-3m, which is different from a space group Fm-3m of a rock-salt crystal (the space group of a general rock-salt crystal); thus, the Miller index of the crystal plane satisfying the above conditions in the layered rock-salt crystal is different from that in the rock-salt crystal. In this specification, in the layered rock-salt crystal and the rock-salt crystal, a state where the orientations of the cubic close-packed structures formed of anions are aligned with each other may be referred to as a state where crystal orientations are substantially aligned with each other.

The orientations of crystals in two regions being substantially aligned with each other can be judged, for example, from a transmission electron microscope (TEM) image, a scanning transmission electron microscope (STEM) image, a high-angle annular dark field scanning TEM (HAADF-STEM) image, an annular bright-field scanning transmission electron microscope (ABF-STEM) image, electron diffraction, and fast Fourier transform (FFT) of a TEM image, a STEM image, and the like. X-ray diffraction (XRD), neutron diffraction, and the like can also be used for judging.

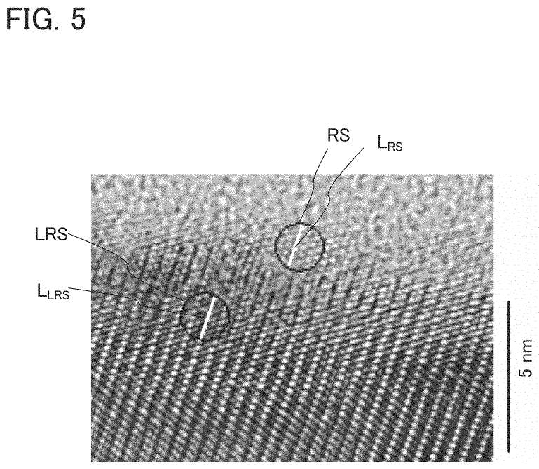

FIG. 5 shows an example of a TEM image in which orientations of a layered rock-salt crystal LRS and a rock-salt crystal RS are substantially aligned with each other. In a TEM image, a STEM image, a HAADF-STEM image, an ABF-STEM image, and the like, an image showing a crystal structure is obtained.

For example, in a high-resolution TEM image, a contrast derived from a crystal plane is obtained. When an electron beam is incident perpendicularly to the c-axis of a composite hexagonal lattice of a layered rock-salt structure, for example, a contrast derived from the (0003) plane is obtained as repetition of bright bands (bright strips) and dark bands (dark strips) because of diffraction and interference of the electron beam. Thus, in the TEM image, repetition of bright lines and dark lines is observed, and the case where the angle between the bright lines (e.g., L_{RS} and L_{LRS} in FIG. 5) is 5° or less or 2.5° or less can be judged that the crystal planes are substantially aligned with each other, that is, orientations of the crystals are substantially aligned with each other. Similarly, the case where the angle between the dark lines is 5° or less or 2.5° or less can be judged that orientations of the crystals are substantially aligned with each other.

In a HAADF-STEM image, a contrast proportional to the atomic number is obtained, and an element having a larger atomic number is observed to be brighter. For example, in the case of layered rock-salt lithium nickel-cobalt-manganese oxide that belongs to the space group R-3m, manganese (atomic number: 25), cobalt (atomic number: 27), and nickel (atomic number: 28), which are the transition metals M, each have a larger atomic number than lithium and oxygen; hence, an electron beam is strongly scattered at the positions of the transition metal M atoms, and arrangement of the transition metal M atoms is observed as bright lines or arrangement of high-luminance dots. Thus, when the lithium nickel-cobalt-manganese oxide having a layered rock-salt crystal structure is observed perpendicularly to the c-axis, arrangement of the transition metals M is observed as bright lines or arrangement of high-luminance dots, and arrangement of lithium atoms and oxygen atoms is observed as dark lines or a low-luminance region in the direction perpendicular to the c-axis. The same applies to the case where fluorine (atomic number: 9) and calcium (atomic number: 20) are included as the additive elements of the lithium nickel-cobalt-manganese oxide.

Consequently, in the HAADF-STEM image, the case where repetition of bright lines and dark lines is observed in two regions having different crystal structures and the angle between the bright lines is 5° or less or 2.5° or less can be judged that arrangements of the atoms are substantially aligned with each other, that is, orientations of the crystals are substantially aligned with each other. Similarly, the case where the angle between the dark lines is 5° or less or 2.5° or less can be judged that orientations of the crystals are substantially aligned with each other.

With an ABF-STEM, an element having a smaller atomic number is observed to be brighter, but a contrast corresponding to the atomic number is obtained as with a HAADF-STEM; hence, in an ABF-STEM image, crystal orientations can be judged as in a HAADF-STEM image.

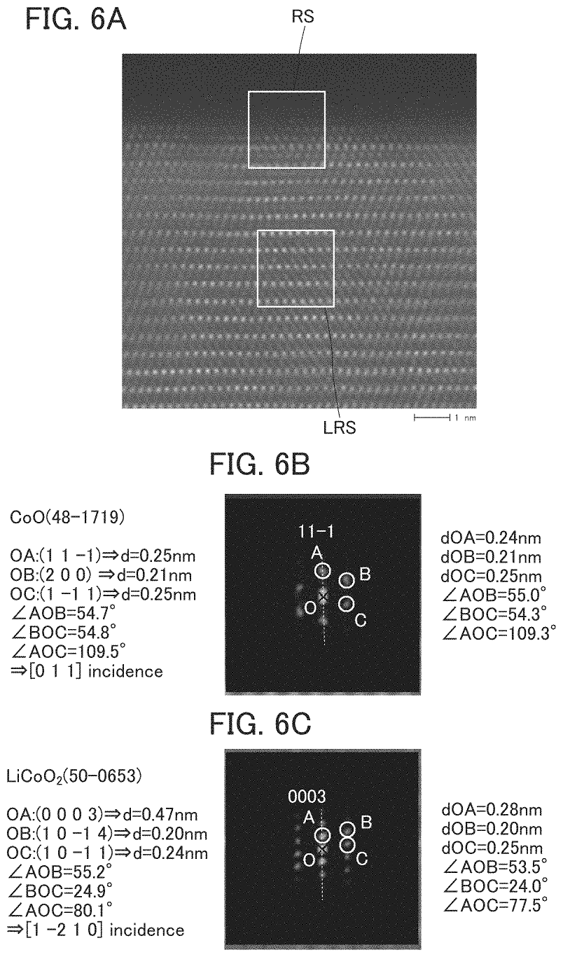

FIG. 6A shows an example of a STEM image in which orientations of the layered rock-salt crystal LRS and the rock-salt crystal RS are substantially aligned with each other. FIG. 6B shows an FFT pattern of a region of the rock-salt crystal RS, and FIG. 6C shows an FFT pattern of a region of the layered rock-salt crystal LRS. In FIG. 6B and FIG. 6C, the composition, the JCPDS card number, and d values and angles to be calculated are shown on the left. The measured values are shown on the right. A spot indicated by O is zero-order diffraction.

A spot indicated by A in FIG. 6B is derived from 11-1 reflection of a cubic structure. A spot indicated by A in FIG. 6C is derived from 0003 reflection of a layered rock-salt structure. It is found from FIG. 6B and FIG. 6C that the direction of the 11-1 reflection of the cubic structure and the direction of the 0003 reflection of the layered rock-salt structure are substantially aligned with each other. That is, a straight line that passes through AO in FIG. 6B is substantially parallel to a straight line that passes through AO in FIG. 6C. Here, the terms “substantially aligned” and “substantially parallel” mean that the angle between the two is 5° or less or 2.5° or less.

When the orientations of the layered rock-salt crystal and the rock-salt crystal are substantially aligned with each other in the above manner in FFT and electron diffraction, the <0003> orientation of the layered rock-salt crystal and the <11-1> orientation of the rock-salt crystal may be substantially aligned with each other. In that case, it is preferred that these reciprocal lattice points be spot-shaped, that is, they be not connected to other reciprocal lattice points. The state where reciprocal lattice points are spot-shaped and not connected to other reciprocal lattice points means high crystallinity.

When the direction of the 11-1 reflection of the cubic structure and the direction of the 0003 reflection of the layered rock-salt structure are substantially aligned with each other as described above, a spot that is not derived from the 0003 reflection of the layered rock-salt structure may be observed, depending on the incident direction of the electron beam, on a reciprocal lattice space different from the direction of the 0003 reflection of the layered rock-salt structure. For example, a spot indicated by B in FIG. 6C is derived from 1014 reflection of the layered rock-salt structure. This is sometimes observed at a position that is at an angle greater than or equal to 52° and less than or equal to 56° (i.e., ∠AOB of 52° to 56°) from the direction of the reciprocal lattice point derived from the 0003 reflection of the layered rock-salt structure (A in FIG. 6C) and has d greater than or equal to 0.19 nm and less than or equal to 0.21 nm. Note that these indices are just an example, and the spot does not necessarily correspond with them and may be, for example, a reciprocal lattice point equivalent to 0003 and 1014.

Similarly, a spot that is not derived from the 11-1 reflection of the cubic structure may be observed on a reciprocal lattice space different from the direction where the 11-1 reflection of the cubic structure is observed. For example, a spot indicated by B in FIG. 6B is derived from 200 reflection of the cubic structure. A diffraction spot is sometimes observed at a position that is at an angle greater than or equal to 54° and less than or equal to 56° (i.e., ∠AOB of 54° to 56°) from the direction of the 11-1 reflection of the cubic structure (A in FIG. 6B). Note that these indices are just an example, and the spot does not necessarily correspond with them and may be, for example, a reciprocal lattice point equivalent to 11-1 and 200.

It is known that in a layered rock-salt positive electrode active material, such as lithium cobalt oxide, the (0003) plane and a plane equivalent thereto and the (10-14) plane and a plane equivalent thereto are likely to be crystal planes. Thus, a sample to be observed can be processed to be thin by FIB or the like such that an electron beam of a TEM, for example, enters in [12-10], in order to easily observe the (0003) plane in careful observation of the shape of the positive electrode active material with a SEM or the like. To judge alignment of crystal orientations, a sample is preferably processed to be thin so that the (0003) plane of the layered rock-salt structure is easily observed.

When the orientations of crystals in the surface portion 101a and the inner portion 101b are substantially aligned with each other, the surface portion 101a and the inner portion 101b are stably bonded to each other. Thus, the use of the positive electrode active material 100 for a secondary battery can effectively suppress a change in the crystal structure of the inner portion 101b caused by charging and discharging. Even when lithium is extracted from the inner portion 101b by charging, the surface portion 101a stably bonded to the inner portion 101b can inhibit extraction of the transition metal M such as cobalt and oxygen from the inner portion 101b. Furthermore, a chemically stable material can be used for a region in contact with the electrolyte solution. Thus, a secondary battery having excellent cycle performance can be provided.

Note that it is not preferable that the surface portion 101a be made of a compound of only the additive element X and oxygen, in which case a lithium insertion/extraction path might be blocked. For example, when the additive element is magnesium, nickel, which is one of the transition metals M, and magnesium might form a solid solution Ni₁₋ₓMgₓO having a rock-salt crystal structure. In that case, if the solid solution Ni₁₋ₓMgₓO occupies a large part of the surface portion 101a, a lithium insertion/extraction path is more likely to be blocked, which is not preferable.

Meanwhile, calcium and barium, although being alkali earth metals like magnesium, do not form a solid solution of a rock-salt oxide with nickel. For that reason, calcium and barium are preferable because a lithium diffusion path is easily maintained.

As described above, the surface portion 101a needs to contain at least the transition metal M, also contain lithium in a discharged state, and have a lithium insertion/extraction path. Moreover, the concentration of the transition metal M is preferably higher than the concentrations of the additive elements X.

Note that the transition metal M, particularly cobalt and nickel, is preferably dissolved uniformly in the entire positive electrode active material 100.

When the additive elements X are distributed in the above manner, deterioration of the positive electrode active material 100 due to charge and discharge can be reduced. That is, deterioration of a secondary battery can be inhibited. Moreover, the secondary battery can be highly safe.

In general, the repetition of charge and discharge of a secondary battery causes changes such as dissolution of the transition metal M from the positive electrode active material included in the secondary battery into an electrolyte solution, release of oxygen, and instability of a crystal structure; hence, deterioration of the positive electrode active material proceeds in some cases. The deterioration of the positive electrode active material might accelerate deterioration such as a decrease in the capacity of the secondary battery. Note that in this specification and the like, a chemical or structural change of the positive electrode active material, such as dissolution of the transition metal M of the positive electrode active material into an electrolyte solution, release of oxygen, and instability of a crystal structure, may be referred to as deterioration of the positive electrode active material. In this specification and the like, a decrease in the capacity of the secondary battery may be referred to as deterioration of the secondary battery.

In some cases, a metal dissolved from the positive electrode active material is reduced at a negative electrode and precipitated, and inhibits the reduction-oxidation reaction at the negative electrode. The precipitation of the metal at the negative electrode may accelerate deterioration such as a decrease in capacity.

In some cases, crystal lattice of the positive electrode active material expands and contracts with insertion and extraction of lithium due to charge and discharge, thereby undergoing strain and a change in volume. The strain and change in volume of the crystal lattice cause cracking of the positive electrode active material, which may accelerate deterioration such as a decrease in capacity. Cracking of the positive electrode active material may start from the interface 103 between the primary particles.

When the temperature inside the secondary battery turns high and oxygen is released from the positive electrode active material, the safety of the secondary battery might be adversely affected. In addition, the release of oxygen might change the crystal structure of the positive electrode active material and accelerate deterioration such as a decrease in capacity. Note that oxygen is sometimes released from the positive electrode active material by insertion and extraction of lithium due to charge and discharge.

In view of the above, the positive electrode active material 100 that is more chemically and structurally stable than a lithium composite oxide represented by LiMO₂ and includes an additive element or a compound (e.g., an oxide of an additive element) in the surface portion 101a or at the interface 103 is formed. Thus, the positive electrode active material 100 can be chemically and structurally stable, and a change in structure, a change in volume, and strain due to charge and discharge can be inhibited. In other words, the crystal structure of the positive electrode active material 100 is more stable and can be prevented from changing with repeated charge and discharge. In addition, cracking of the positive electrode active material 100 can be inhibited. That is, deterioration such as a decrease in capacity can be reduced, which is preferable. When the charging voltage is high and the amount of lithium in the positive electrode at the time of charging decreases, the crystal structure becomes unstable and is more likely to deteriorate. The use of the positive electrode active material 100 of one embodiment of the present invention is particularly preferable, in which case the crystal structure can be more stable and thus deterioration such as a decrease in capacity can be inhibited.

Since the positive electrode active material 100 of one embodiment of the present invention has a stable crystal structure, dissolution of the transition metal M from the positive electrode active material can be inhibited. That is, deterioration such as a reduction in capacity can be reduced, which is preferable.

When the positive electrode active material 100 of one embodiment of the present invention is cracked along the interface 103 between the primary particles 101, the compound of the additive element is included in the surfaces of the cracked primary particles 101. That is, changes such as release of oxygen and instability of a crystal structure can be inhibited in the cracked positive electrode active material 100; hence, deterioration of the positive electrode active material 100 can be reduced. That is, deterioration of the secondary battery can be inhibited.

The contents described in this embodiment can be implemented in combination with the contents described in any of the other embodiments.

### Embodiment 3

In this embodiment, a lithium-ion secondary battery including the positive electrode active material of one embodiment of the present invention will be described. The secondary battery at least includes an exterior body, a current collector, an active material (a positive electrode active material or a negative electrode active material), a conductive material, and a binder. The secondary battery also includes an electrolyte solution in which a lithium salt or the like is dissolved. In the secondary battery using an electrolyte solution, a positive electrode, a negative electrode, and a separator between the positive electrode and the negative electrode are provided.

### [Positive Electrode]

The positive electrode includes a positive electrode active material layer and a positive electrode current collector. The positive electrode active material layer preferably includes the positive electrode active material described in Embodiment 2, and may also include a binder, a conductive material, and the like.

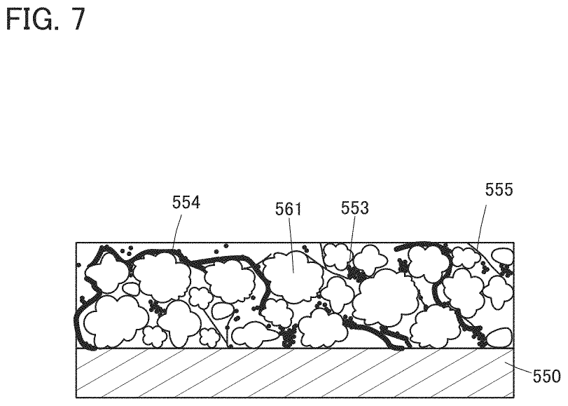

FIG. 7 shows an example of a schematic cross-sectional view of the positive electrode.

A current collector 550 is metal foil, and the positive electrode is formed by applying slurry onto the metal foil and drying the slurry. Pressing may be performed after drying. The positive electrode is a component obtained by forming an active material layer over the current collector 550.

Slurry refers to a material solution that is used to form an active material layer over the current collector 550 and includes at least an active material, a binder, and a solvent, preferably also a conductive material mixed therewith. Slurry may also be referred to as slurry for an electrode or active material slurry; in some cases, slurry for forming a positive electrode active material layer is referred to as slurry for a positive electrode, and slurry for forming a negative electrode active material layer is referred to as slurry for a negative electrode.

A conductive material is also referred to as a conductivity-imparting agent and a conductive additive, and a carbon material is used as the conductive material. A conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following concepts: the case covalent bonding occurs, the case where bonding with the Van der Waals force occurs, the case where a conductive material covers part of the surface of an active material, the case where a conductive material is embedded in surface roughness of an active material, and the case where an active material and a conductive material are electrically connected to each other without being in contact with each other.

Typical examples of the carbon material used as the conductive material include carbon black (e.g., furnace black, acetylene black, and graphite).

In FIG. 7, acetylene black 553, graphene and a graphene compound 554, and a carbon nanotube 555 are shown as the conductive material. Note that the positive electrode active material 100 described in Embodiment 1 corresponds to an active material 561 in FIG. 7.

In the positive electrode of the secondary battery, a binder (a resin) is mixed in order to fix the current collector 550 such as metal foil and the active material. The binder is also referred to as a binding agent. Since the binder is a high molecular material, a large amount of binder lowers the proportion of the active material in the positive electrode, thereby reducing the discharge capacity of the secondary battery.

Therefore, the amount of binder mixed is reduced to a minimum.

Graphene, which has electrically, mechanically, or chemically remarkable characteristics, is a carbon material that is expected to be applied to a variety of fields, such as field-effect transistors and solar batteries.

A graphene compound in this specification and the like refers to multilayer graphene, multi graphene, graphene oxide, multilayer graphene oxide, multi graphene oxide, reduced graphene oxide, reduced multilayer graphene oxide, reduced multi graphene oxide, and the like. A graphene compound contains carbon, has a plate-like shape, a sheet-like shape, or the like, and has a two-dimensional structure formed of a six-membered ring of carbon atoms. A graphene compound is preferably bent. A graphene compound may also be referred to as a carbon sheet. A graphene compound preferably includes a functional group. A graphene compound may be rounded like a carbon nanofiber.

The graphene and graphene compound may have excellent electrical characteristics of high conductivity and excellent physical properties of high flexibility and high mechanical strength. The graphene and graphene compound have a sheet-like shape. The graphene and graphene compound sometimes have a curved surface, thereby enabling low-resistant surface contact. Furthermore, the graphene and graphene compound sometimes have extremely high conductivity even with a small thickness, and thus a small amount of graphene and a graphene compound allows a conductive path to be efficiently formed in an active material layer. Hence, the use of the graphene and graphene compound as the conductive material can increase the area where the active material and the conductive material are in contact with each other. Note that the graphene and graphene compound preferably cling (stick) to at least part of the secondary particle 102 in the positive electrode active material 100. The graphene and graphene compound preferably overlay (superpose) at least part of the active material. The shape of the graphene and graphene compound preferably conforms to (mirrors) at least part of the shape of the secondary particle 102. The shape of the secondary particle 102 means, for example, a projection and a depression of the secondary particle 102 or projections and depressions formed by a plurality of secondary particles 102. The graphene and graphene compound preferably surround at least part of the secondary particle 102. The graphene and graphene compound may have a hole (opening).

In FIG. 7, a region that is not filled with the active material 561, the graphene and graphene compound 554, the acetylene black 553, or the carbon nanotube 555 represents a space or the binder. A space is required for the electrolyte solution to penetrate the positive electrode; too many spaces lower the electrode density, too few spaces do not allow the electrolyte solution to penetrate the positive electrode, and a space that remains after the secondary battery is completed lowers the energy density.

Note that all of the acetylene black 553, the graphene and graphene compound 554, and the carbon nanotube 555 are not necessarily included as the conductive material. At least one kind of conductive material is needed.

The positive electrode active material 100 obtained in Embodiment 1 is used in the positive electrode, whereby a secondary battery having a high energy density and favorable output characteristics can be obtained.

A secondary battery can be fabricated by using the positive electrode in FIG. 7; setting, in a container (e.g., an exterior body or a metal can), a stack in which a separator is provided over the positive electrode and a negative electrode is provided over the separator; and filling the container with an electrolyte solution.

Although the above structure is an example of a secondary battery using an electrolyte solution, one embodiment of the present invention is not limited thereto.

For example, a semi-solid-state battery or an all-solid-state battery can be fabricated using the positive electrode active material 100 described in Embodiment 1.

In this specification and the like, a semi-solid-state battery refers to a battery in which at least one of an electrolyte layer, a positive electrode, and a negative electrode includes a semi-solid-state material. The term “semi-solid-state” here does not mean that the proportion of a solid-state material is 50%. The term “semi-solid-state” means having properties of a solid, such as a small volume change, and also having some of properties close to those of a liquid, such as flexibility. A single material or a plurality of materials can be used to satisfy the above properties. For example, a porous solid-state material infiltrated with a liquid material may be used.

In this specification and the like, a polymer electrolyte secondary battery refers to a secondary battery in which an electrolyte layer between a positive electrode and a negative electrode includes a polymer. Polymer electrolyte secondary batteries include a dry (or true) polymer electrolyte battery and a polymer gel electrolyte battery. A polymer electrolyte secondary battery may be referred to as a semi-solid-state battery.

A semi-solid-state battery fabricated using the positive electrode active material 100 described in Embodiment 1 is a secondary battery having high charge and discharge capacity. The semi-solid-state battery can have high charging and discharging voltages. Alternatively, a highly safe or highly reliable semi-solid-state battery can be achieved.

The positive electrode active material described in Embodiment 1 and another positive electrode active material may be mixed to be used.

Examples of another positive electrode active material include composite oxides having an olivine crystal structure, a layered rock-salt crystal structure, and a spinel crystal structure. Examples include compounds such as LiFePO₄, LiFeO₂, LiNiO₂, LiMn₂O₄, V₂O₅, Cr₂O₅, and MnO₂.

As another positive electrode active material, it is preferable to mix lithium nickel oxide (LiNiO₂ or LiNi₁₋ₓMₓO₂ (0<x<1) (M=Co, Al, or the like)) with a lithium-containing material that has a spinel crystal structure and contains manganese, such as LiMn₂O₄. This composition can improve the characteristics of the secondary battery.

Another example of another positive electrode active material is a lithium-manganese composite oxide that can be represented by a composition formula LiₐMn_{b}M_{c}O_{d}. Here, the element M is preferably silicon, phosphorus, or a metal element other than lithium and manganese, and further preferably nickel. When the whole particle of a lithium-manganese composite oxide is measured, it is preferable to satisfy the following at the time of discharging: 0<a/(b+c)<2; c>0; and 0.26 (b+c)/d<0.5. Note that the proportions of metals, silicon, phosphorus, and the like in the whole particle of a lithium-manganese composite oxide can be measured with, for example, an ICP-MS. The proportion of oxygen in the whole particle of a lithium-manganese composite oxide can be measured by, for example, energy dispersive X-ray spectroscopy (EDX). Moreover, the proportion of oxygen can be measured using fusion gas analysis and valence evaluation with X-ray absorption fine structure (XAFS) spectroscopy in combination with ICP-MS analysis. Note that a lithium-manganese composite oxide is an oxide containing at least lithium and manganese, and may contain one or more selected from chromium, cobalt, aluminum, nickel, iron, magnesium, molybdenum, zinc, indium, gallium, copper, titanium, niobium, silicon, phosphorus, and the like.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

As the binder, for example, water-soluble polymers are preferably used. As the water-soluble polymers, a polysaccharide can be used, for example. Examples of the polysaccharide include cellulose derivatives such as carboxymethyl cellulose (CMC), methyl cellulose, ethyl cellulose, hydroxypropyl cellulose, diacetyl cellulose, and regenerated cellulose and starch. It is further preferable that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

At least two of the above materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. An example of a water-soluble polymer having a significant viscosity modifying effect is the above-mentioned polysaccharide; for instance, a cellulose derivative such as carboxymethyl cellulose (CMC), methyl cellulose, ethyl cellulose, hydroxypropyl cellulose, diacetyl cellulose, or regenerated cellulose, or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material and other components in the formation of slurry for an electrode. In this specification, cellulose and a cellulose derivative used as a binder of an electrode include salts thereof.

A water-soluble polymer stabilizes the viscosity by being dissolved in water and allows stable dispersion of the active material or another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a passivation film refers to a film without electric conductivity or a film with extremely low electric conductivity, and can inhibit the decomposition of an electrolyte solution at a potential at which a battery reaction occurs when the passivation film is formed on the active material surface, for example. It is preferred that the passivation film can conduct lithium ions while suppressing electrical conduction.

### <Positive Electrode Current Collector>

The positive electrode current collector can be formed using a material that has high conductivity, such as a metal like stainless steel, gold, platinum, aluminum, or titanium, or an alloy thereof. It is preferred that a material used for the positive electrode current collector not dissolve at the potential of the positive electrode. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### [Negative Electrode]

The negative electrode includes a negative electrode active material layer and a negative electrode current collector. The negative electrode active material layer includes a negative electrode active material, and may also include a conductive material and a binder.

### <Negative Electrode Active Material>

As the negative electrode active material, an alloy-based material, a carbon-based material, or a mixture thereof can be used, for example.

As the negative electrode active material, an element that enables charge and discharge reactions by alloying and dealloying reactions with lithium can be used. For example, a material containing one or more selected from silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, Sn₅₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by alloying and dealloying reactions with lithium, a compound containing the element, and the like may be referred to as an alloy-based material.

In this specification and the like, SiO refers to silicon monoxide, for example. Note that SiO can alternatively be expressed as SiOₓ. Here, it is preferred that x be 1 or have an approximate value of 1. For example, x is preferably more than or equal to 0.2 and less than or equal to 1.5, further preferably more than or equal to 0.3 and less than or equal to 1.2.

As the carbon-based material, graphite, graphitizing carbon (soft carbon), non-graphitizing carbon (hard carbon), carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are intercalated into the graphite (while a lithium-graphite intercalation compound is generated). For this reason, a lithium-ion secondary battery using graphite can have a high operating voltage. In addition, graphite is preferred because of its advantages such as a relatively high capacity per unit volume, relatively small volume expansion, low cost, and higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M is Co, Ni, or Cu) with a Li₃N structure, which is a nitride containing lithium and a transition metal, can be used. For example, Li₂₆Co_{0.4}N₃ is preferable because of high charge and discharge capacity (900 mAh/g and 1890 mAh/cm³).

A nitride containing lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that in the case of using a material containing lithium ions as a positive electrode active material, the nitride containing lithium and a transition metal can be used as the negative electrode active material by extracting the lithium ions contained in the positive electrode active material in advance.

Alternatively, a material that causes a conversion reaction can be used as the negative electrode active material. For example, a transition metal oxide that does not form an alloy with lithium, such as cobalt oxide (CoO), nickel oxide (NiO), and iron oxide (FeO), may be used. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive material and the binder that can be included in the negative electrode active material layer, materials similar to those for the conductive material and the binder that can be included in the positive electrode active material layer can be used.

### <Negative Electrode Current Collector>

For the negative electrode current collector, copper or the like can be used in addition to a material similar to that for the positive electrode current collector. Note that a material that is not alloyed with carrier ions of lithium or the like is preferably used for the negative electrode current collector.

### [Separator]

The separator is positioned between the positive electrode and the negative electrode. The separator can be formed using, for example, a fiber containing cellulose, such as paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably processed into a bag-like shape to enclose one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charging and discharging at high voltage can be suppressed and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Electrolyte Solution]

The electrolyte solution contains a solvent and an electrolyte. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

Alternatively, the use of one or more kinds of ionic liquids (room temperature molten salts) which have features of non-flammability and non-volatility as the solvent of the electrolyte solution can prevent a power storage device from exploding and catching fire even when the power storage device internally shorts out or the internal temperature increases owing to overcharging or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, and lithium bis(oxalate)borate (LiB(C₂O₄)₂, LiBOB) can be used, or two or more of these lithium salts can be used in an appropriate combination in an appropriate ratio.

The electrolyte solution used for the power storage device is preferably highly purified and contains a small amount of dust particles and elements other than the constituent elements of the electrolyte solution (hereinafter also simply referred to as impurities). Specifically, the weight ratio of impurities to the electrolyte solution is preferably less than or equal to 1%, further preferably less than or equal to 0.1%, still further preferably less than or equal to 0.01%.

Furthermore, an additive agent such as vinylene carbonate, propane sultone (PS), tert-butylbenzene (TBB), fluoroethylene carbonate (FEC), lithium bis(oxalate)borate (LiBOB), or a dinitrile compound like succinonitrile or adiponitrile may be added to the electrolyte solution. The concentration of such an additive agent in the solvent is, for example, higher than or equal to 0.1 wt % and lower than or equal to 5 wt %.

Alternatively, a polymer gel electrolyte obtained in such a manner that a polymer is swelled with an electrolyte solution may be used.

When a polymer gel electrolyte is used, safety against liquid leakage and the like is improved. Moreover, the secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used. For example, a polymer having a polyalkylene oxide structure, such as polyethylene oxide (PEO), PVDF, polyacrylonitrile, or a copolymer containing any of them can be used. For example, PVDF-HFP, which is a copolymer of PVDF and hexafluoropropylene (HFP), can be used. The formed polymer may be porous.

Instead of the electrolyte solution, a solid electrolyte including an inorganic material such as a sulfide-based or oxide-based inorganic material, or a solid electrolyte including a polymer material such as a polyethylene oxide (PEO)-based polymer material may alternatively be used. When the solid electrolyte is used, a separator or a spacer is not necessary. Furthermore, the battery can be entirely solidified; therefore, there is no possibility of liquid leakage and thus the safety of the battery is dramatically improved.

Accordingly, the positive electrode active material 100 obtained in Embodiment 1 can also be applied to all-solid-state batteries. By using the positive electrode slurry or the electrode in an all-solid-state battery, an all-solid-state battery with a high degree of safety and favorable characteristics can be obtained.

### [Exterior Body]

For the exterior body included in the secondary battery, a metal material such as aluminum or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of polyethylene, polypropylene, polycarbonate, ionomer, polyamide, or the like and an insulating synthetic resin film of a polyamide-based resin, a polyester-based resin, or the like is provided over the metal thin film as the outer surface of the exterior body.

The contents described in this embodiment can be combined with the contents described in any of the other embodiments.

### Embodiment 4

This embodiment will describe examples of shapes of several types of secondary batteries including a positive electrode or a negative electrode formed by the manufacturing method described in the foregoing embodiment.

### [Coin-Type Secondary Battery]

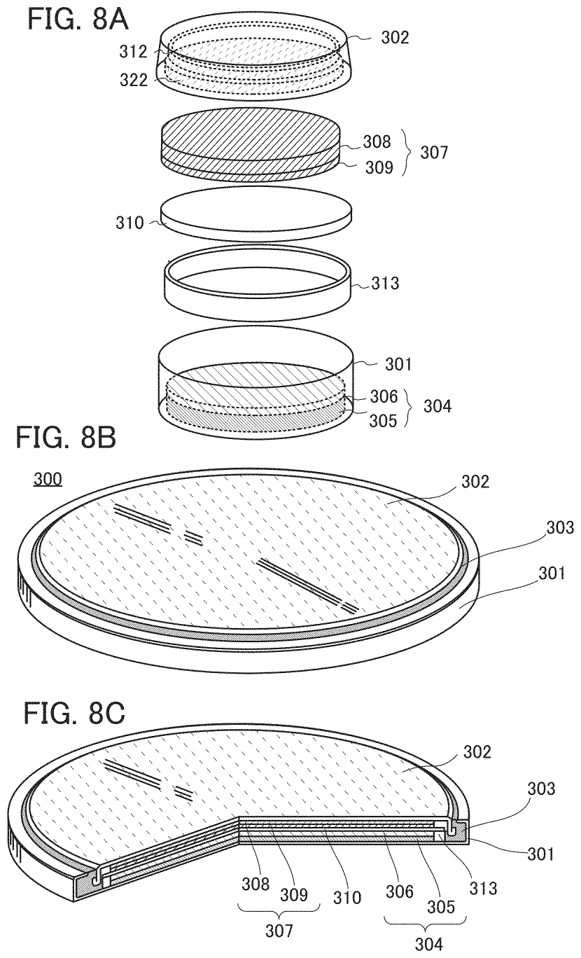

An example of a coin-type secondary battery is described. FIG. 8A, FIG. 8B, and FIG. 8C are an exploded perspective view, an external view, and a cross-sectional view of a coin-type (single-layer flat) secondary battery. Coin-type secondary batteries are mainly used in small electronic devices. In this specification and the like, coin-type batteries include button-type batteries.

For easy understanding, FIG. 8A is a schematic view showing overlap (a vertical relation and a positional relation) between components. Thus, FIG. 8A and FIG. 8B do not completely correspond with each other.

In FIG. 8A, a positive electrode 304, a separator 310, a negative electrode 307, a spacer 322, and a washer 312 are overlaid. They are sealed with a negative electrode can 302 and a positive electrode can 301. Note that a gasket for sealing is not illustrated in FIG. 8A. The spacer 322 and the washer 312 are used to protect the inside or fix the position of the components inside the cans at the time when the positive electrode can 301 and the negative electrode can 302 are bonded with pressure. For the spacer 322 and the washer 312, stainless steel or an insulating material is used.

The positive electrode 304 is a stack in which a positive electrode active material layer 306 is formed over a positive electrode current collector 305.

To prevent a short circuit between the positive electrode and the negative electrode, the separator 310 and a ring-shaped insulator 313 are provided to cover the side surface and top surface of the positive electrode 304. The separator 310 has a larger flat surface area than the positive electrode 304.

FIG. 8B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte solution, for example. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 8C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is manufactured.

With this structure, the coin-type secondary battery 300 can have high capacity and excellent cycle performance.

### [Cylindrical Secondary Battery]

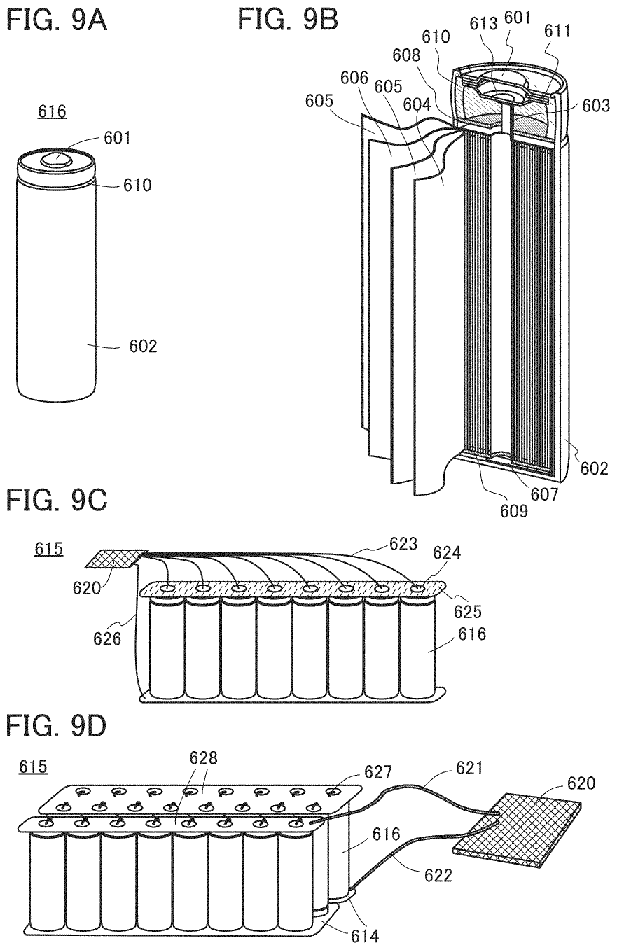

An example of a cylindrical secondary battery is described with reference to FIG. 9A. As illustrated in FIG. 9A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 9B schematically illustrates a cross section of a cylindrical secondary battery. The cylindrical secondary battery illustrated in FIG. 9B includes the positive electrode cap (battery cap) 601 on the top surface and the battery can (outer can) 602 on the side and bottom surfaces. The positive electrode cap 601 and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a strip-like separator 605 located therebetween is provided. Although not illustrated, the battery element is wound around the central axis. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. The inside of the battery can 602 provided with the battery element is filled with a nonaqueous electrolyte solution (not illustrated). As the nonaqueous electrolyte solution, an electrolyte solution similar to that for the coin-type secondary battery can be used.

Since the positive electrode and the negative electrode of the cylindrical storage battery are wound, active materials are preferably formed on both sides of the current collectors. Although FIGS. 9A to 9D each illustrate the secondary battery 616 in which the height of the cylinder is larger than the diameter of the cylinder, one embodiment of the present invention is not limited thereto. In a secondary battery, the diameter of the cylinder may be larger than the height of the cylinder. Such a structure can reduce the size of a secondary battery, for example.

The positive electrode active material 100 obtained in Embodiment 1 is used in the positive electrode 604, whereby the cylindrical secondary battery 616 can have high capacity and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a positive temperature coefficient (PTC) element 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

FIG. 9C illustrates an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a protection circuit for preventing overcharge or overdischarge can be used, for example.

FIG. 9D illustrates an example of the power storage system 615. The power storage system 615 includes a plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel or connected in series. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 9D, the power storage system 615 is electrically connected to the control circuit 620 through a wiring 621 and a wiring 622. The wiring 621 is electrically connected to the positive electrodes of the plurality of secondary batteries 616 through the conductive plate 628. The wiring 622 is electrically connected to the negative electrodes of the plurality of secondary batteries 616 through the conductive plate 614.

### [Other Structure Examples of Secondary Battery]

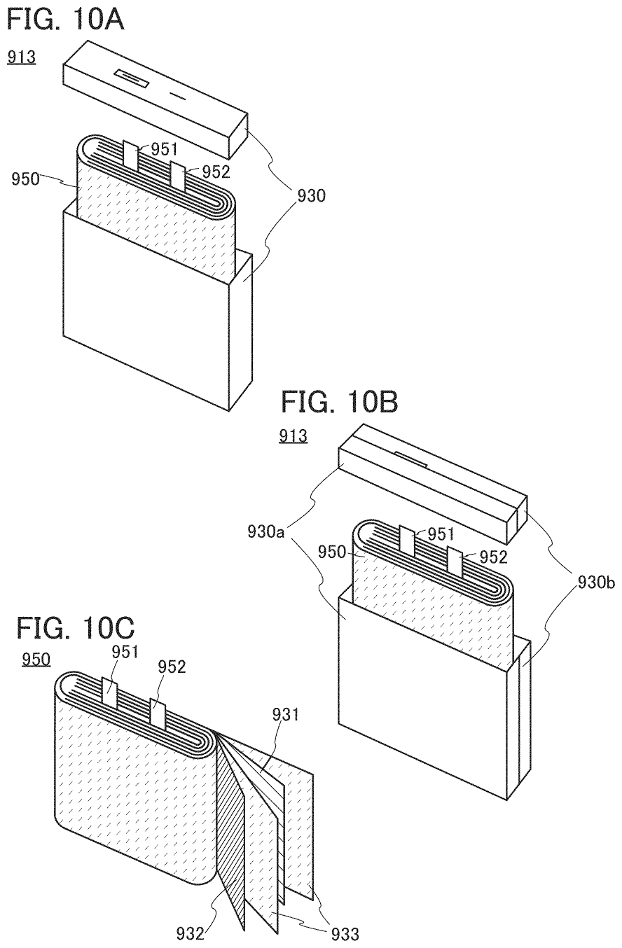

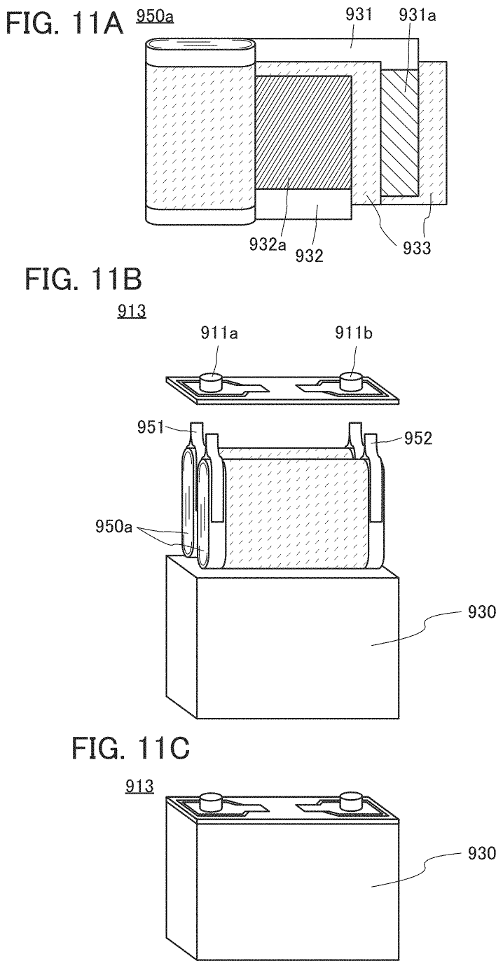

Structure examples of secondary batteries are described with reference to FIGS. 10A to 10C and FIGS. 11A to 11C.

A secondary battery 913 illustrated in FIG. 10A includes a wound body 950 provided with a terminal 951 and a terminal 952 inside a housing 930. The wound body 950 is immersed in an electrolyte solution inside the housing 930. The terminal 952 is in contact with the housing 930. The use of an insulator or the like inhibits contact between the terminal 951 and the housing 930. Note that in FIG. 10A, the housing 930 divided into two pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 10B, the housing 930 in FIG. 10A may be formed using a plurality of materials. For example, in the secondary battery 913 in FIG. 10B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 10C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be overlaid.

As illustrated in FIGS. 11A to 11C, the secondary battery 913 may include a wound body 950a. The wound body 950a illustrated in FIG. 11A includes the negative electrode 931, the positive electrode 932, and the separators 933. The negative electrode 931 includes a negative electrode active material layer 931a. The positive electrode 932 includes a positive electrode active material layer 932a.

The positive electrode active material 100 obtained in Embodiment 1 is used in the positive electrode 932, whereby the secondary battery 913 can have high capacity and excellent cycle performance.

The separator 933 has a larger width than the negative electrode active material layer 931a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 11B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 11C, the wound body 950a and an electrolyte solution are covered with the housing 930, whereby the secondary battery 913 is completed. The housing 930 is preferably provided with a safety valve, an overcurrent protection element, and the like. A safety valve is a valve to be released by a predetermined internal pressure of the housing 930 in order to prevent the battery from exploding.

As illustrated in FIG. 11B, the secondary battery 913 may include a plurality of wound bodies 950a. The use of the plurality of wound bodies 950a enables the secondary battery 913 to have higher charge and discharge capacity. The description of the secondary battery 913 in FIGS. 10A to 10C can be referred to for the other components of the secondary battery 913 in FIGS. 11A and 11B.

### <Laminated Secondary Battery>

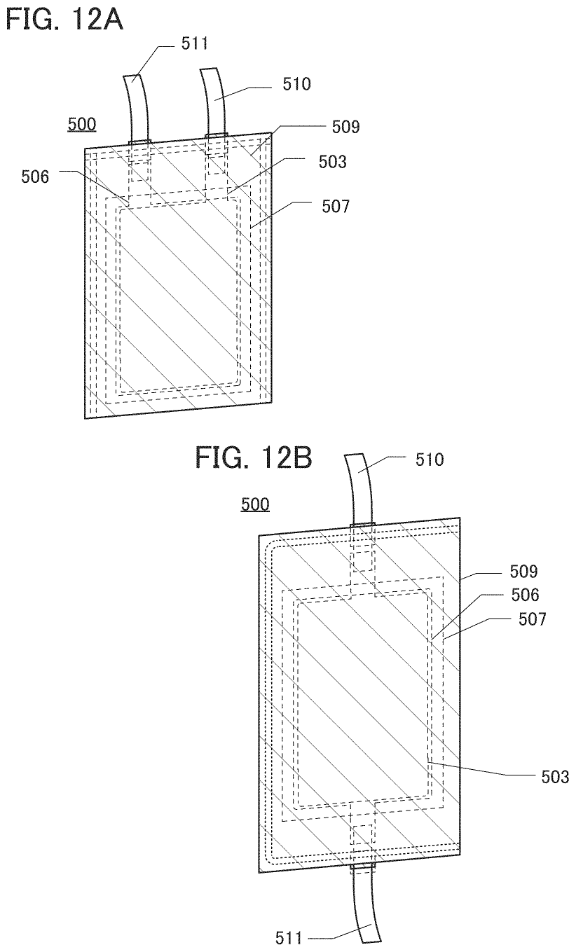

Next, examples of the appearance of a laminated secondary battery are shown in FIGS. 12A and 12B. FIGS. 12A and 12B each illustrate a positive electrode 503, a negative electrode 506, a separator 507, an exterior body 509, a positive electrode lead electrode 510, and a negative electrode lead electrode 511.

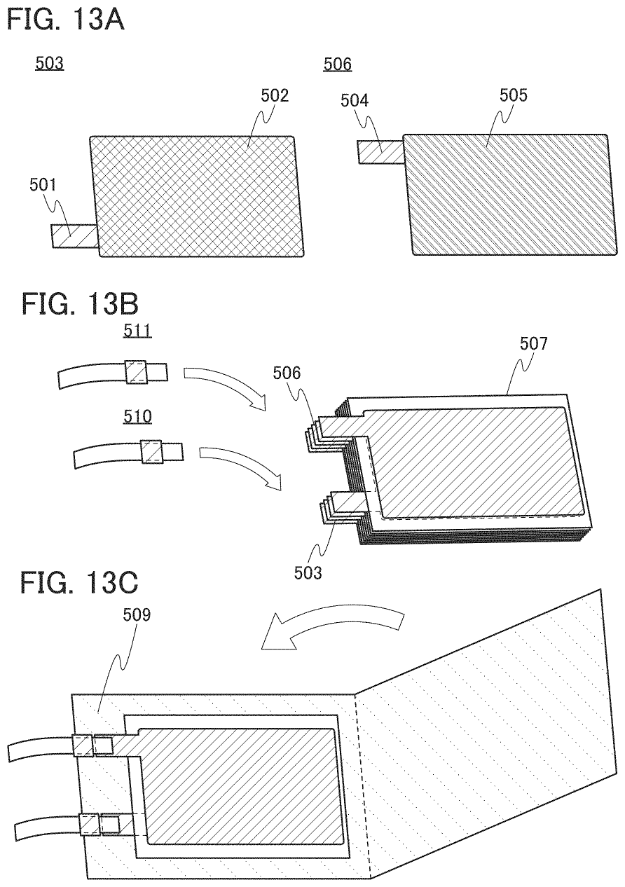

FIG. 13A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to those illustrated in FIG. 13A.

### <Method for Manufacturing Laminated Secondary Battery>

Here, an example of a method for manufacturing the laminated secondary battery having the appearance illustrated in FIG. 12A will be described with reference to FIGS. 13B and 13C.

First, the negative electrode 506, the separator 507, and the positive electrode 503 are stacked. FIG. 13B illustrates the negative electrodes 506, the separators 507, and the positive electrodes 503 that are stacked. The secondary battery described here as an example includes five negative electrodes and four positive electrodes. The component at this stage can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a dashed line as illustrated in FIG. 13C. Then, the outer edges of the exterior body 509 are bonded to each other. The bonding can be performed by thermocompression, for example. At this time, a part (or one side) of the exterior body 509 is left unbonded (to provide an inlet) so that an electrolyte solution 508 can be introduced later.

Next, the electrolyte solution 508 (not illustrated) is introduced into the exterior body 509 from the inlet of the exterior body 509. The electrolyte solution 508 is preferably introduced in a reduced pressure atmosphere or in an inert atmosphere. Lastly, the inlet is sealed by bonding. In this manner, the laminated secondary battery 500 can be manufactured.

The positive electrode active material 100 obtained in Embodiment 1 is used in the positive electrodes 503, whereby the secondary battery 500 can have high capacity and excellent cycle performance.

### [Examples of Battery Pack]

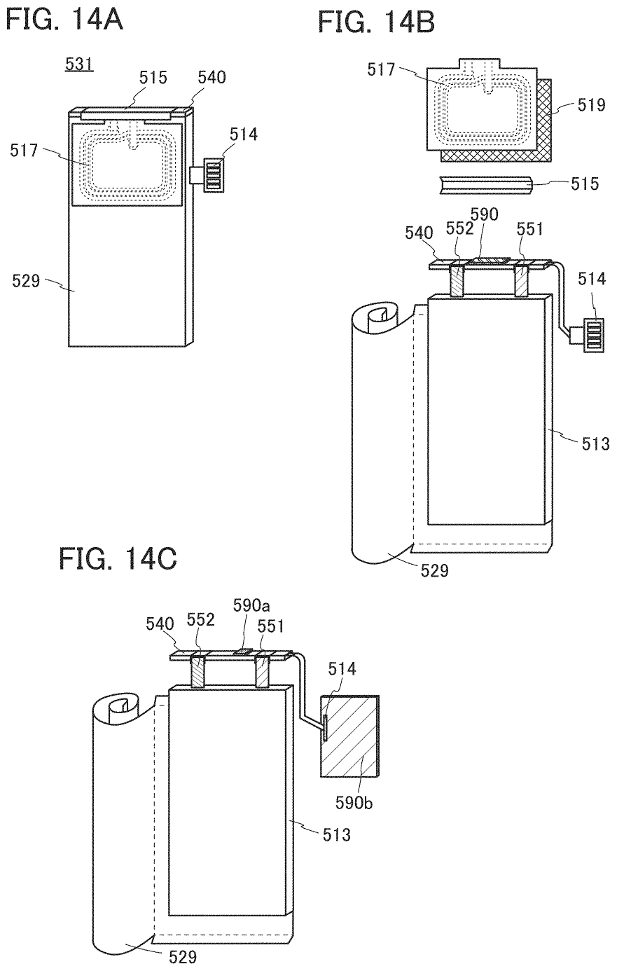

Examples of a secondary battery pack of one embodiment of the present invention that is capable of wireless charging using an antenna will be described with reference to FIGS. 14A to 14C.

FIG. 14A illustrates the appearance of a secondary battery pack 531 that has a rectangular solid shape with a small thickness (also referred to as a flat plate shape with a certain thickness). FIG. 14B illustrates the structure of the secondary battery pack 531. The secondary battery pack 531 includes a circuit board 540 and a secondary battery 513. A label 529 is attached to the secondary battery 513. The circuit board 540 is fixed by a sealant 515. The secondary battery pack 531 also includes an antenna 517.

As for the internal structure of the secondary battery 513, the secondary battery 513 may include a wound body or a stack.

In the secondary battery pack 531, a control circuit 590 is provided over the circuit board 540 as illustrated in FIG. 14B, for example. The circuit board 540 is electrically connected to a terminal 514. Moreover, the circuit board 540 is electrically connected to the antenna 517 and a positive electrode lead and a negative electrode lead 551 and 552 of the secondary battery 513.

Alternatively, as illustrated in FIG. 14C, a circuit system 590a provided over the circuit board 540 and a circuit system 590b electrically connected to the circuit board 540 through the terminal 514 may be included.

Note that the shape of the antenna 517 is not limited to a coil shape and may be a linear shape or a plate shape, for example. Furthermore, a planar antenna, an aperture antenna, a traveling-wave antenna, an EH antenna, a magnetic-field antenna, a dielectric antenna, or the like may be used. Alternatively, the antenna 517 may be a flat-plate conductor. The flat-plate conductor can serve as one of conductors for electric field coupling. That is, the antenna 517 can function as one of two conductors of a capacitor. Thus, electric power can be transmitted and received not only by an electromagnetic field or a magnetic field but also by an electric field.

The secondary battery pack 531 includes a layer 519 between the antenna 517 and the secondary battery 513. The layer 519 has a function of blocking an electromagnetic field from the secondary battery 513, for example. As the layer 519, a magnetic material can be used, for example.

The contents in this embodiment can be freely combined with the contents in any of the other embodiments.

### Embodiment 5

This embodiment will describe an example where an all-solid-state battery is manufactured using the positive electrode active material 100 obtained in Embodiment 1.

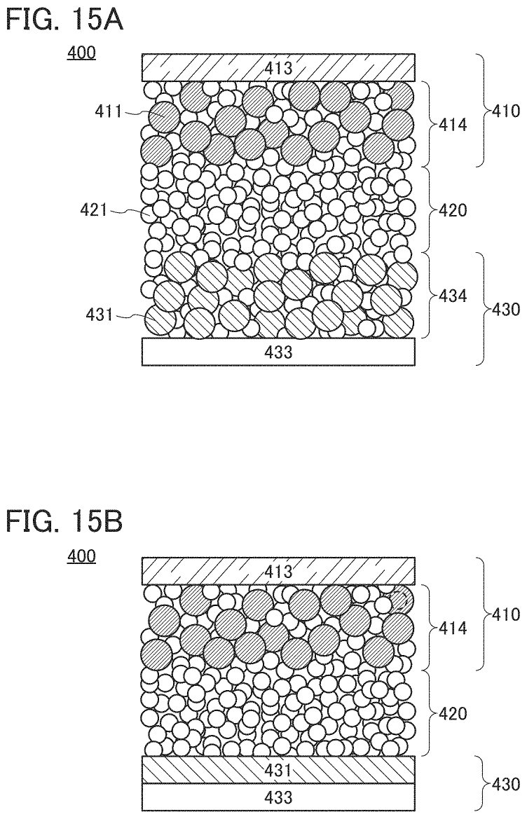

As illustrated in FIG. 15A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. The positive electrode active material 100 obtained in Embodiment 1 is used as the positive electrode active material 411. The positive electrode active material layer 414 may also include a conductive material and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may also include a conductive material and a binder. Note that when metal lithium is used as the negative electrode active material 431, metal lithium does not need to be processed into particles; thus, the negative electrode 430 that does not include the solid electrolyte 421 can be formed, as illustrated in FIG. 15B. The use of metal lithium for the negative electrode 430 is preferable, in which case the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

Examples of the sulfide-based solid electrolyte include a thio-silicon-based material (e.g., Li₁₀GeP₂S₁₂ and Li_{3.25}Ge_{0.25}P_{0.75}S₄), sulfide glass (e.g., 70Li₂S.30P₂S₅, 30Li₂S.26B₂S_{3.44}LiI, 63Li₂S.36SiS_{2.1}Li₃PO₄, 57Li₂S.38SiS₂.5Li₄SiO₄, and 50Li₂S.50GeS₂), and sulfide-based crystallized glass (e.g., Li₇P₃S₁₁ and Li_{3.25}P_{0.95}S₄). The sulfide-based solid electrolyte has advantages such as high conductivity of some materials, low-temperature synthesis, and ease of maintaining a path for electrical conduction after charging and discharging because of its relative softness.

Examples of the oxide-based solid electrolyte include a material with a perovskite crystal structure (e.g., La_{2/3}-xLi₃ₓTiO₃), a material with a NASICON crystal structure (e.g., Li_{1-y}Al_{y}Ti_{2-y}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄.50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃ (0≤x≤1) having a NASICON crystal structure (hereinafter LATP) is preferable because LATP contains aluminum and titanium, each of which is the element the positive electrode active material used in the secondary battery 400 of one embodiment of the present invention is allowed to contain, and thus a synergistic effect of improving the cycle performance is expected. Moreover, higher productivity due to the reduction in the number of steps is expected. Note that in this specification and the like, a material having a NASICON crystal structure refers to a compound that is represented by M₂(XO₄)₃ (M: transition metal; X: S, P, As, Mo, W, or the like) and has a structure in which MO₆ octahedra and XO₄ tetrahedra that share common corners are arranged three-dimensionally.

### [Exterior Body and Shape of Secondary Battery]

An exterior body of the secondary battery 400 of one embodiment of the present invention can employ a variety of materials and have a variety of shapes, and preferably has a function of applying pressure to the positive electrode, the solid electrolyte layer, and the negative electrode.

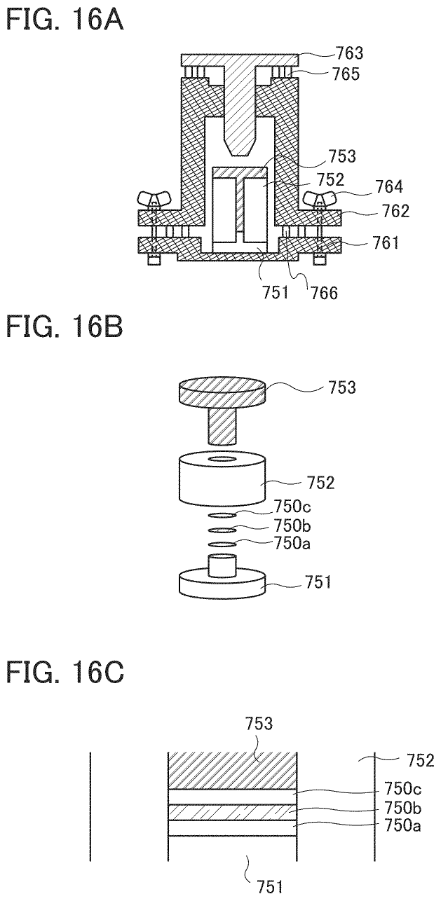

FIGS. 16A to 16C show an example of a cell for evaluating materials of an all-solid-state battery.

FIG. 16A is a schematic cross-sectional view of the evaluation cell. The evaluation cell includes a lower component 761, an upper component 762, and a fixation screw/butterfly nut 764 for fixing these components. By rotating a pressure screw 763, an electrode plate 753 is pressed to fix an evaluation material. An insulator 766 is provided between the lower component 761 and the upper component 762 that are made of a stainless steel material. An 0 ring 765 for hermetic sealing is provided between the upper component 762 and the pressure screw 763.

The evaluation material is placed on an electrode plate 751, surrounded by an insulating tube 752, and pressed from above by the electrode plate 753. FIG. 16B is an enlarged perspective view of the evaluation material and its vicinity.

A stack of a positive electrode 750a, a solid electrolyte layer 750b, and a negative electrode 750c is shown here as an example of the evaluation material, and its cross section is shown in FIG. 16C. Note that the same portions in FIGS. 16A to 16C are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance or the like can be measured while pressure is applied to the evaluation material through the electrode plate 751 and the electrode plate 753.

The exterior body of the secondary battery of one embodiment of the present invention is preferably a package having excellent airtightness. For example, a ceramic package or a resin package can be used. The exterior body is sealed preferably in a closed atmosphere where the outside air is blocked, for example, in a glove box.

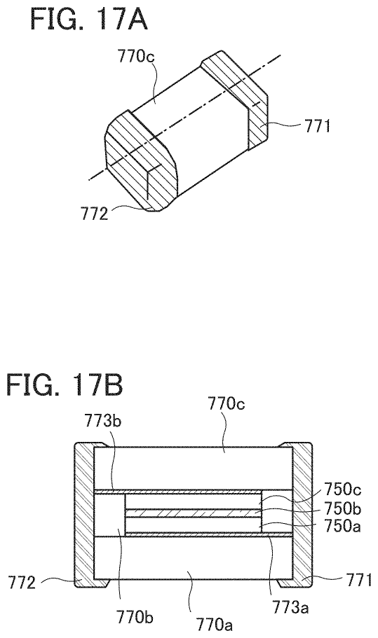

FIG. 17A is a perspective view of a secondary battery of one embodiment of the present invention that has an exterior body and a shape different from those in FIGS. 16A to 16C. The secondary battery in FIG. 17A includes external electrodes 771 and 772 and is sealed with an exterior body including a plurality of package components.

FIG. 17B illustrates an example of a cross section along the dashed-dotted line in FIG. 17A. A stack including the positive electrode 750a, the solid electrolyte layer 750b, and the negative electrode 750c is surrounded and sealed by a package component 770a including an electrode layer 773a on a flat plate, a frame-like package component 770b, and a package component 770c including an electrode layer 773b on a flat plate. For the package components 770a, 770b, and 770c, an insulating material such as a resin material or ceramic can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

The use of the positive electrode active material 100 obtained in Embodiment 1 achieves an all-solid-state secondary battery having a high energy density and favorable output characteristics.

The contents in this embodiment can be combined with the contents in any of the other embodiments as appropriate.

### Embodiment 6

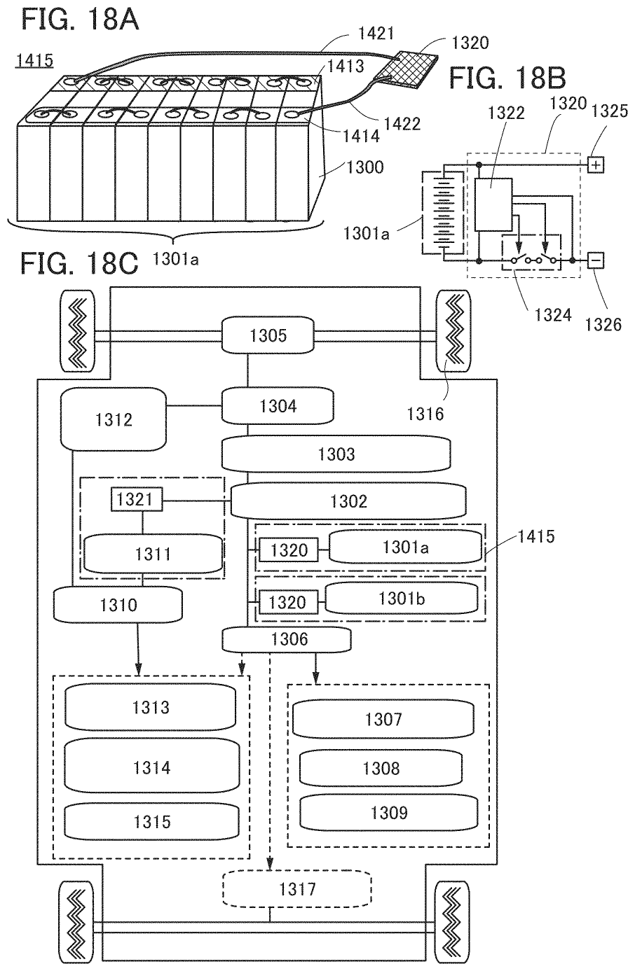

In this embodiment, an example in which a secondary battery different from the cylindrical secondary battery in FIG. 9D is used in an electric vehicle (EV) will be described with reference to FIG. 18C.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery and a starter battery. The second battery 1311 specifically needs high output and does not necessarily have high capacity, and the capacity of the second battery 1311 is lower than that of the first batteries 1301a and 1301b.

The internal structure of the first battery 1301a may be the wound structure illustrated in FIG. 10A or FIG. 11C or the stacked structure illustrated in FIG. 12A or FIG. 12B. Alternatively, the first battery 1301a may be the all-solid-state battery in Embodiment 5. Using the all-solid-state battery in Embodiment 5 as the first battery 1301a achieves high capacity, a high degree of safety, and reduction in size and weight.

Although this embodiment shows an example where the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. A plurality of secondary batteries can be collectively referred to as an assembled battery.

An in-vehicle secondary battery includes a service plug or a circuit breaker that can cut off high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (such as an electric power steering 1307, a heater 1308, and a defogger 1309) through a DC-DC circuit 1306. In the case where there is a rear motor 1317 for the rear wheels, the first battery 1301a is used to rotate the rear motor 1317.

The second battery 1311 supplies electric power to in-vehicle parts for 14V (such as an audio 1313, power windows 1314, and lamps 1315) through a DC-DC circuit 1310.

The first battery 1301a is described with reference to FIG. 18A.

FIG. 18A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode of each battery is fixed by a fixing portion 1414 made of an insulator. Although this embodiment shows an example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414, a battery container box, or the like. Furthermore, the one electrode of each battery is electrically connected to a control circuit portion 1320 through a wiring 1421. The other electrode of each battery is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor may be referred to as a battery operating system or a battery oxide semiconductor (BTOS).

A metal oxide functioning as an oxide semiconductor is preferably used. For example, as the oxide, a metal oxide such as an In-M-Zn oxide (the element M is one or more of aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is used. In particular, the In-M-Zn oxide that can be used as the oxide is preferably a c-axis aligned crystal oxide semiconductor (CAAC-OS) or a cloud-aligned composite oxide semiconductor (CAC-OS). Alternatively, an In—Ga oxide or an In—Zn oxide may be used as the oxide. The CAAC-OS is an oxide semiconductor that has a plurality of crystal regions each of which has c-axis alignment in a particular direction. Note that the particular direction refers to the thickness direction of a CAAC-OS film, the normal direction of the surface where the CAAC-OS film is formed, or the normal direction of the surface of the CAAC-OS film. The crystal region refers to a region having a periodic atomic arrangement. When an atomic arrangement is regarded as a lattice arrangement, the crystal region also refers to a region with a uniform lattice arrangement. The CAAC-OS has a region where a plurality of crystal regions are connected in the a-b plane direction, and the region has distortion in some cases. Note that distortion refers to a portion where the direction of a lattice arrangement changes between a region with a uniform lattice arrangement and another region with a uniform lattice arrangement in a region where a plurality of crystal regions are connected. That is, the CAAC-OS is an oxide semiconductor having c-axis alignment and having no clear alignment in the a-b plane direction. In addition, the CAC-OS has, for example, a composition in which elements included in a metal oxide are unevenly distributed. Materials including unevenly distributed elements each have a size greater than or equal to 0.5 nm and less than or equal to 10 nm, preferably greater than or equal to 1 nm and less than or equal to 3 nm, or a similar size. Note that in the following description of a metal oxide, a state in which one or more types of metal elements are unevenly distributed and regions including the metal element(s) are mixed is referred to as a mosaic pattern or a patch-like pattern. The regions each have a size greater than or equal to 0.5 nm and less than or equal to 10 nm, preferably greater than or equal to 1 nm and less than or equal to 3 nm, or a similar size.

In addition, the CAC-OS has a composition in which materials are separated into a first region and a second region to form a mosaic pattern, and the first regions are distributed in the film. This composition is hereinafter also referred to as a cloud-like composition. That is, the CAC-OS is a composite metal oxide having a composition in which the first regions and the second regions are mixed.

Here, the atomic ratios of In, Ga, and Zn to the metal elements contained in the CAC-OS in an In—Ga—Zn oxide are denoted by [In], [Ga], and [Zn], respectively. For example, the first region in the CAC-OS in the In—Ga—Zn oxide has [In] higher than that in the composition of the CAC-OS film. Moreover, the second region of the CAC-OS in the In—Ga—Zn oxide has [Ga] higher than that in the composition of the CAC-OS film. Alternatively, for example, the first region has higher [In] and lower [Ga] than the second region. Moreover, the second region has higher [Ga] and lower [In] than the first region.

Specifically, the first region includes indium oxide, indium zinc oxide, or the like as its main component. The second region includes gallium oxide, gallium zinc oxide, or the like as its main component. That is, the first region can be referred to as a region containing In as its main component. The second region can be referred to as a region containing Ga as its main component.

Note that a clear boundary between the first region and the second region cannot be observed in some cases.

For example, according to EDX mapping obtained by energy dispersive X-ray spectroscopy (EDX), the CAC-OS in the In—Ga—Zn oxide has a composition in which the region containing In as its main component (the first region) and the region containing Ga as its main component (the second region) are unevenly distributed and mixed.

In the case where the CAC-OS is used for a transistor, a switching function (on/off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Thus, when the CAC-OS is used for a transistor, high on-state current (Iₒₙ), high field-effect mobility (μ), and excellent switching operation can be achieved.

An oxide semiconductor can have any of various structures that show various different properties. Two or more of an amorphous oxide semiconductor, a polycrystalline oxide semiconductor, an a-like OS, the CAC-OS, an nc-OS, and the CAAC-OS may be included in an oxide semiconductor of one embodiment of the present invention.

The control circuit portion 1320 preferably uses a transistor using an oxide semiconductor because the transistor using an oxide semiconductor can be used in a high-temperature environment. For the process simplicity, the control circuit portion 1320 may be formed using transistors of the same conductivity type. A transistor using an oxide semiconductor in its semiconductor layer has an operating ambient temperature range of −40° C. to 150° C., which is wider than that of a single crystal Si transistor, and thus shows a smaller change in characteristics than the single crystal Si transistor when the secondary battery is overheated. The off-state current of the transistor using an oxide semiconductor is lower than or equal to the lower measurement limit even at 150° C. On the other hand, the off-state current of the single crystal Si transistor largely depends on the temperature. For example, at 150° C., the off-state current of the single crystal Si transistor increases, and a sufficiently high current on/off ratio cannot be obtained. The control circuit portion 1320 can improve the degree of safety. When the control circuit portion 1320 is used in combination with a secondary battery having a positive electrode using the positive electrode active material 100 obtained in Embodiment 1, the synergy on safety can be obtained.

The control circuit portion 1320 that uses a memory circuit including a transistor using an oxide semiconductor can also function as an automatic control device for the secondary battery to resolve causes of instability, such as a micro-short circuit. Examples of functions of resolving the causes of instability include prevention of overcharge, prevention of overcurrent, control of overheating during charge, maintenance of cell balance of an assembled battery, prevention of overdischarge, a battery indicator, automatic control of charging voltage and current amount according to temperature, control of the amount of charge current according to the degree of deterioration, abnormal behavior detection for a micro-short circuit, and anomaly prediction regarding a micro-short circuit. The control circuit portion 1320 has at least one of these functions. Furthermore, the automatic control device for the secondary battery can be extremely small in size.

A micro-short circuit refers to a minute short circuit caused in a secondary battery. A micro-short circuit refers to not a state where the positive electrode and the negative electrode of a secondary battery are short-circuited so that charging and discharging are impossible, but a phenomenon in which a slight short-circuit current flows through a minute short-circuit portion. Since a large voltage change is caused even when a micro-short circuit occurs in a relatively short time in a minute area, the abnormal voltage value might adversely affect inference performed subsequently to estimate the charge and discharge state and the like of the secondary battery.

One of the supposed causes of a micro-short circuit is as follows. Uneven distribution of a positive electrode active material due to multiple charges and discharges causes local current concentration at part of the positive electrode and part of the negative electrode; thus, a malfunction of part of a separator is caused. Another supposed cause is generation of a by-product due to a side reaction.

It can be said that the control circuit portion 1320 not only detects a micro-short circuit but also detects a terminal voltage of the secondary battery and controls the charge and discharge state of the secondary battery. For example, to prevent overcharge, the control circuit portion 1320 can turn off an output transistor of a charging circuit and an interruption switch substantially at the same time.

FIG. 18B shows an example of a block diagram of the battery pack 1415 illustrated in FIG. 18A.

The control circuit portion 1320 includes a switch portion 1324 that includes at least a switch for preventing overcharge and a switch for preventing overdischarge, a control circuit 1322 for controlling the switch portion 1324, and a portion for measuring the voltage of the first battery 1301a. The control circuit portion 1320 is set to have the upper limit voltage and the lower limit voltage of the secondary battery used, and imposes the upper limit of current from the outside, the upper limit of output current to the outside, and the like. The range from the lower limit voltage to the upper limit voltage of the secondary battery falls within the recommended voltage range. When a voltage falls outside the range, the switch portion 1324 operates and functions as a protection circuit. The control circuit portion 1320 can also be referred to as a protection circuit because it controls the switch portion 1324 to prevent overdischarge and overcharge. For example, when the control circuit 1322 detects a voltage that is likely to cause overcharge, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to including a switch having a Si transistor using single crystal silicon; the switch portion 1324 may be formed using a power transistor containing germanium (Ge), silicon germanium (SiGe), gallium arsenide (GaAs), gallium aluminum arsenide (GaAlAs), indium phosphide (InP), silicon carbide (SiC), zinc selenide (ZnSe), gallium nitride (GaN), gallium oxide (GaOₓ, where x is a real number greater than 0), or the like. A memory element using an OS transistor can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the control circuit portion 1320 using OS transistors can be stacked over the switch portion 1324 so that they can be integrated into one chip. Since the area occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system).

In this embodiment, an example in which a lithium-ion secondary battery is used as both the first battery 1301a and the second battery 1311 is described. As the second battery 1311, a lead storage battery, an all-solid-state battery, or an electric double layer capacitor may alternatively be used. For example, the all-solid-state battery in Embodiment 5 may be used. Using the all-solid-state battery in Embodiment 5 as the second battery 1311 achieves high capacity, a high degree of safety, and reduction in size and weight.

Regenerative energy generated by rolling of tires 1316 is transmitted to the motor 1304 through a gear 1305, and is stored in the second battery 1311 through a motor controller 1303, a battery controller 1302, and the control circuit portion 1321. Alternatively, the regenerative energy is stored in the first battery 1301a through the battery controller 1302 and the control circuit portion 1320. Alternatively, the regenerative energy is stored in the first battery 1301b through the battery controller 1302 and the control circuit portion 1320. For efficient charging with regenerative energy, the first batteries 1301a and 1301b are preferably capable of fast charging.

The battery controller 1302 can set the charging voltage, charge current, and the like of the first batteries 1301a and 1301b. The battery controller 1302 can set charge conditions in accordance with charging characteristics of a secondary battery used, so that fast charging can be performed.

Although not illustrated, when the electric vehicle is connected to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharge, the first batteries 1301a and 1301b are preferably charged through the control circuit portion 1320. In addition, a plug of the charger or a connection cable of the charger is sometimes provided with a control circuit. The control circuit portion 1320 is also referred to as an electronic control unit (ECU). The ECU is connected to a controller area network (CAN) provided in the electric vehicle. The CAN is a type of a serial communication standard used as an in-vehicle LAN. The ECU includes a microcomputer. Moreover, the ECU uses a CPU or a GPU.

External chargers installed at charging stations and the like have a 100 V outlet, a 200 V outlet, or a three-phase 200V outlet with 50 kW, for example. Furthermore, charging can be performed by electric power supplied from external charging equipment with a contactless power feeding method or the like.

For fast charging, secondary batteries that can withstand charging at high voltage have been desired to perform charging in a short time.

The above-described secondary battery in this embodiment uses the positive electrode active material 100 obtained in Embodiment 1. Moreover, it is possible to achieve a secondary battery in which graphene is used as a conductive material, the electrode layer is formed thick to suppress a reduction in capacity while increasing the loading amount, and the electrical characteristics are significantly improved in synergy with maintenance of high capacity. This secondary battery is particularly effectively used in a vehicle and can achieve a vehicle that has a long range, specifically a driving range per charge of 500 km or greater, without increasing the proportion of the weight of the secondary battery to the weight of the entire vehicle.

Specifically, in the secondary battery in this embodiment, the use of the positive electrode active material 100 described in Embodiment 1 can increase the operating voltage, and the increase in charging voltage can increase the available capacity. Moreover, using the positive electrode active material 100 described in Embodiment 1 in the positive electrode can provide an automotive secondary battery having excellent cycle performance.

Next, examples in which the secondary battery of one embodiment of the present invention is mounted on a vehicle, typically a transport vehicle, will be described.

Mounting the secondary battery or the power storage device illustrated in any of FIG. 9C, FIG. 11C, and FIG. 18A on vehicles can achieve next-generation clean energy vehicles such as hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft. The secondary battery of one embodiment of the present invention can have high capacity. Thus, the secondary battery of one embodiment of the present invention is suitable for reduction in size and weight and is preferably used in transport vehicles.

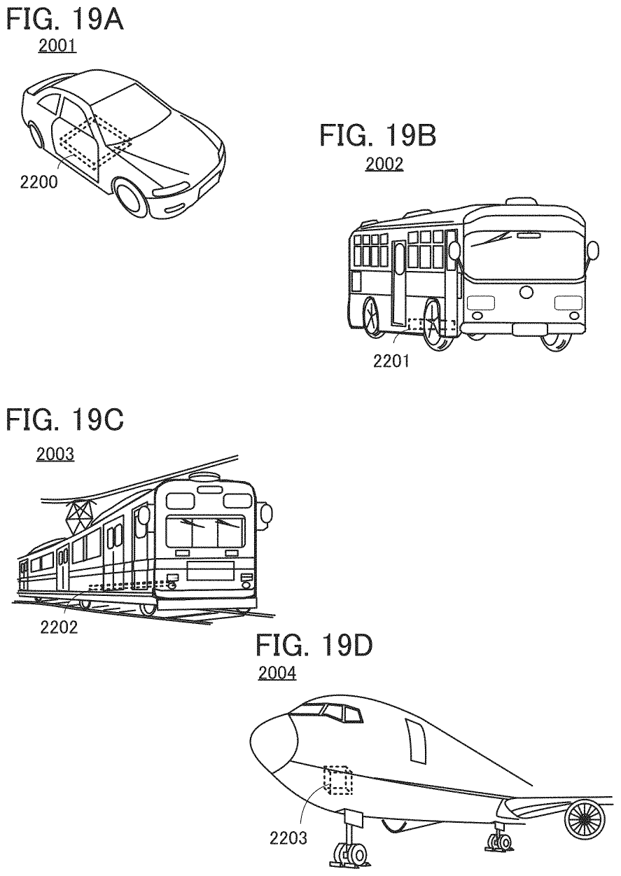

FIGS. 19A to 19D illustrate examples of transport vehicles using one embodiment of the present invention. An automobile 2001 illustrated in FIG. 19A is an electric vehicle that runs on the power of an electric motor. Alternatively, the automobile 2001 is a hybrid electric vehicle capable of driving using either an electric motor or an engine as appropriate. In the case where the secondary battery is mounted on the vehicle, the secondary battery exemplified in Embodiment 4 is provided at one position or several positions. The automobile 2001 illustrated in FIG. 19A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery included in the automobile 2001 is supplied with electric power through external charging equipment by a plug-in system, a contactless power feeding system, or the like. In charging, a given method such as CHAdeMO (registered trademark) or Combined Charging System can be employed as a charging method, the standard of a connector, and the like as appropriate. A charging device may be a charging station provided in a commerce facility or a power source in a house. For example, with the use of the plug-in technique, the power storage device mounted on the automobile 2001 can be charged by being supplied with electric power from outside. The charging can be performed by converting AC electric power into DC electric power through a converter such as an AC-DC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops and moves. To supply electric power in such a contactless manner, an electromagnetic induction method or a magnetic resonance method can be used.

FIG. 19B illustrates a large transporter 2002 having a motor controlled by electricity as an example of a transport vehicle. A secondary battery module of the transporter 2002 includes a cell unit of four secondary batteries with a nominal voltage of 3.0 V or higher and 5.0 V or lower, for example, and 48 cells are connected in series to have a maximum voltage of 170 V. A battery pack 2201 has the same function as that in FIG. 19A except, for example, the number of secondary batteries configuring the secondary battery module; thus, the description is omitted.

FIG. 19C illustrates a large transportation vehicle 2003 having a motor controlled by electricity as an example. A secondary battery module of the transportation vehicle 2003 has more than 100 secondary batteries with a nominal voltage of 3.0 V or higher and 5.0 V or lower connected in series, and the maximum voltage is 600 V. With the use of the positive electrode using the positive electrode active material 100 described in Embodiment 1, a secondary battery having favorable rate characteristics and charge and discharge cycle performance can be fabricated, which can contribute to higher performance and a longer life of the transport vehicle 2003. A battery pack 2202 has the same function as that in FIG. 19A except, for example, the number of secondary batteries configuring the secondary battery module; thus, the description is omitted.

FIG. 19D illustrates an aircraft 2004 having a combustion engine as an example. The aircraft 2004 illustrated in FIG. 19D is regarded as a transport vehicle because it has wheels for takeoff and landing, and includes a battery pack 2203 that includes a charge control device and a secondary battery module configured by connecting a plurality of secondary batteries.

The secondary battery module of the aircraft 2004 has eight 4 V secondary batteries connected in series and has a maximum voltage of 32 V, for example. The battery pack 2203 has the same function as that in FIG. 19A except, for example, the number of secondary batteries configuring the secondary battery module; thus, the description is omitted.

The contents in this embodiment can be combined with the contents in any of the other embodiments as appropriate.

### Embodiment 7

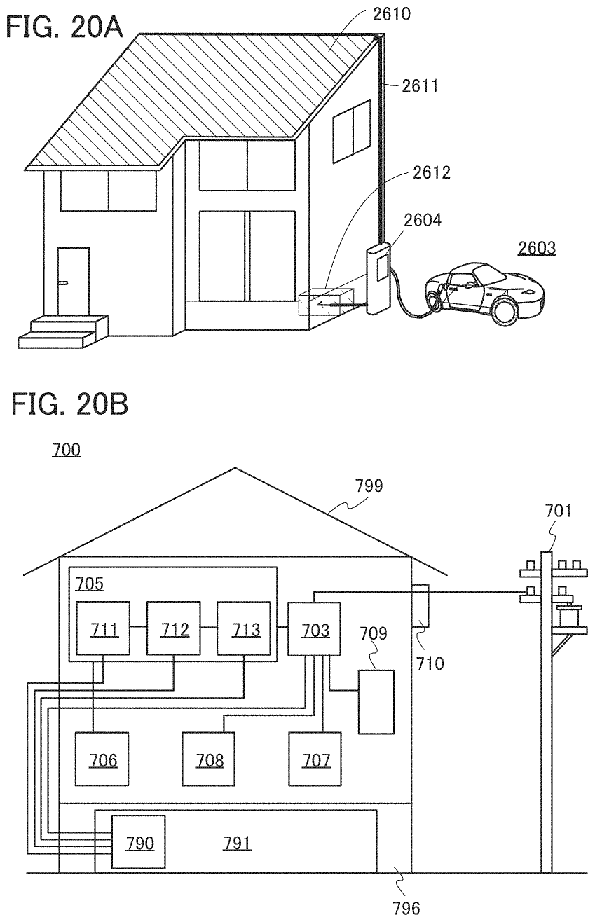

In this embodiment, examples in which the secondary battery of one embodiment of the present invention is mounted on a building will be described with reference to FIGS. 20A and 20B.

A house illustrated in FIG. 20A includes a power storage device 2612 including the secondary battery of one embodiment of the present invention and a solar panel 2610. The power storage device 2612 is electrically connected to the solar panel 2610 through a wiring 2611 or the like. The power storage device 2612 may be electrically connected to a ground-based charging device 2604. The power storage device 2612 can be charged with electric power generated by the solar panel 2610. A secondary battery included in a vehicle 2603 can be charged with the electric power stored in the power storage device 2612 through the charging device 2604. The power storage device 2612 is preferably provided in the underfloor space, in which case the space on the floor can be effectively used. Alternatively, the power storage device 2612 may be provided on the floor.

The electric power stored in the power storage device 2612 can also be supplied to other electronic devices in the house. Thus, the electronic devices can be operated with the use of the power storage device 2612 of one embodiment of the present invention as an uninterruptible power source even when electric power cannot be supplied from the commercial power supply due to power failure or the like.

FIG. 20B illustrates an example of the power storage device 700 of one embodiment of the present invention. As illustrated in FIG. 20B, a power storage device 791 of one embodiment of the present invention is provided in an underfloor space 796 of a building 799. The power storage device 791 may be provided with the control circuit described in Embodiment 6, and the use of a secondary battery including a positive electrode using the positive electrode active material 100 obtained in Embodiment 1 enables the power storage device 791 to have a long lifetime.

The power storage device 791 is provided with a control device 790, and the control device 790 is electrically connected to a distribution board 703, a power storage controller (also referred to as control device) 705, an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electrical device such as a TV or a personal computer. The power storage load 708 is, for example, an electrical device such as a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may also have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The indicator 706 can show the amount of electric power consumed by the general load 707 and the power storage load 708 that is measured by the measuring portion 711. An electrical device such as a TV or a personal computer can also show it through the router 709. Furthermore, a portable electronic terminal such as a smartphone or a tablet can also show it through the router 709. The indicator 706, the electrical device, and the portable electronic terminal can also show, for example, the demand for electric power depending on a time period (or per hour) that is predicted by the predicting portion 712.

The contents in this embodiment can be combined with the contents in any of the other embodiments as appropriate.

### Embodiment 8

This embodiment will describe examples in which the power storage device of one embodiment of the present invention is mounted on a motorcycle and a bicycle.

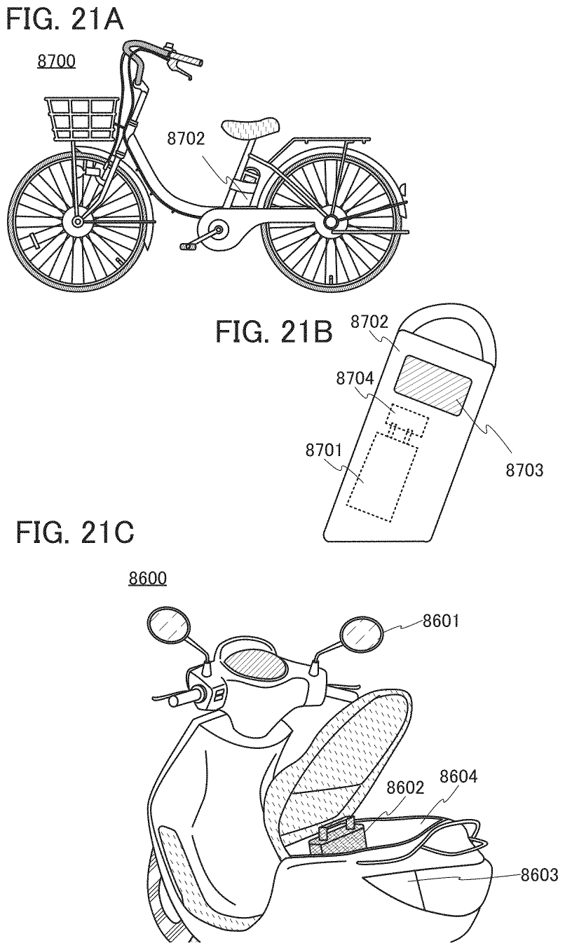

FIG. 21A illustrates an example of an electric bicycle using the power storage device of one embodiment of the present invention. The power storage device of one embodiment of the present invention can be used for an electric bicycle 8700 in FIG. 21A. The power storage device of one embodiment of the present invention includes a plurality of storage batteries and a protection circuit, for example.

The electric bicycle 8700 is provided with a power storage device 8702. The power storage device 8702 can supply electric power to a motor that assists a rider. The power storage device 8702 is portable, and FIG. 21B shows the state where the power storage device 8702 is removed from the electric bicycle. The power storage device 8702 incorporates a plurality of storage batteries 8701 included in the power storage device of one embodiment of the present invention, and can display the remaining battery level and the like on a display portion 8703. The power storage device 8702 includes a control circuit 8704 capable of charge control or anomaly detection for the secondary battery, which is exemplified in Embodiment 6. The control circuit 8704 is electrically connected to a positive electrode and a negative electrode of the storage battery 8701. The control circuit 8704 may include the small solid-state secondary battery illustrated in FIGS. 17A and 17B. When the small solid-state secondary battery illustrated in FIGS. 17A and 17B is provided in the control circuit 8704, electric power can be supplied to store data in a memory circuit included in the control circuit 8704 for a long time. When the control circuit 8704 is used in combination with a secondary battery having a positive electrode using the positive electrode active material 100 obtained in Embodiment 1, the synergy on safety can be obtained. The secondary battery having the positive electrode using the positive electrode active material 100 obtained in Embodiment 1 and the control circuit 8704 can contribute greatly to elimination of accidents due to secondary batteries, such as fires.

FIG. 21C illustrates an example of a motorcycle using the power storage device of one embodiment of the present invention. A motor scooter 8600 illustrated in FIG. 21C includes a power storage device 8602, side mirrors 8601, and indicators 8603. The power storage device 8602 can supply electric power to the indicators 8603. The power storage device 8602 including a plurality of secondary batteries having a positive electrode using the positive electrode active material 100 obtained in Embodiment 1 can have high capacity and contribute to a reduction in size.

In the motor scooter 8600 illustrated in FIG. 21C, the power storage device 8602 can be held in an under-seat storage unit 8604. The power storage device 8602 can be held in the under-seat storage unit 8604 even with a small size.

The contents in this embodiment can be combined with the contents in any of the other embodiments as appropriate.

### Embodiment 9

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game console, a portable information terminal, an audio reproducing device, and a large-sized game machine such as a pachinko machine. Examples of the portable information terminal include a laptop personal computer, a tablet terminal, an e-book reader, and a mobile phone.

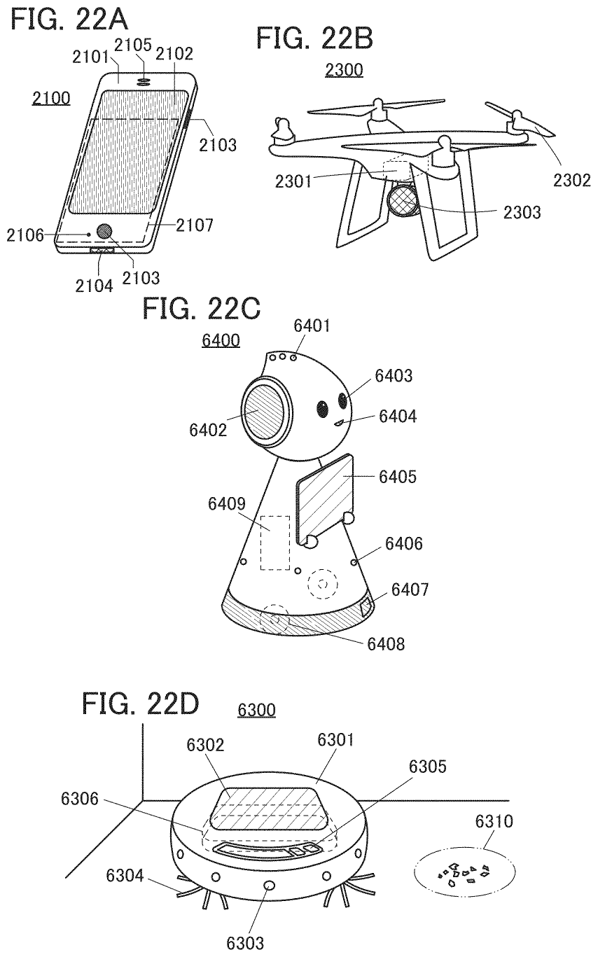

FIG. 22A illustrates an example of a mobile phone. A mobile phone 2100 includes a housing 2101 in which a display portion 2102 is incorporated, an operation button 2103, an external connection port 2104, a speaker 2105, a microphone 2106, and the like. The mobile phone 2100 includes a secondary battery 2107. The use of the secondary battery 2107 having a positive electrode using the positive electrode active material 100 described in Embodiment 1 achieves high capacity and a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication based on an existing communication standard. For example, mutual communication between the mobile phone 2100 and a headset capable of wireless communication can be performed, and thus hands-free calling is possible.

Moreover, the mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 22B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the positive electrode active material 100 obtained in Embodiment 1 has a high energy density and a high degree of safety, and thus can be used safely for a long time over a long period of time and is preferable as the secondary battery included in the unmanned aircraft 2300.

FIG. 22C illustrates an example of a robot. A robot 6400 illustrated in FIG. 22C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including a positive electrode using the positive electrode active material 100 obtained in Embodiment 1 has a high energy density and a high degree of safety, and thus can be used safely for a long time over a long period of time and is preferable as the secondary battery 6409 included in the robot 6400.

FIG. 22D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object that is likely to be caught in the brush 6304 (e.g., a wire) by image analysis, the rotation of the brush 6304 can be stopped. The cleaning robot 6300 further includes, in its inner region, the secondary battery 6306 of one embodiment of the present invention and a semiconductor device or an electronic component. A secondary battery including a positive electrode using the positive electrode active material 100 obtained in Embodiment 1 has a high energy density and a high degree of safety, and thus can be used safely for a long time over a long period of time and is preferable as the secondary battery 6306 included in the cleaning robot 6300.

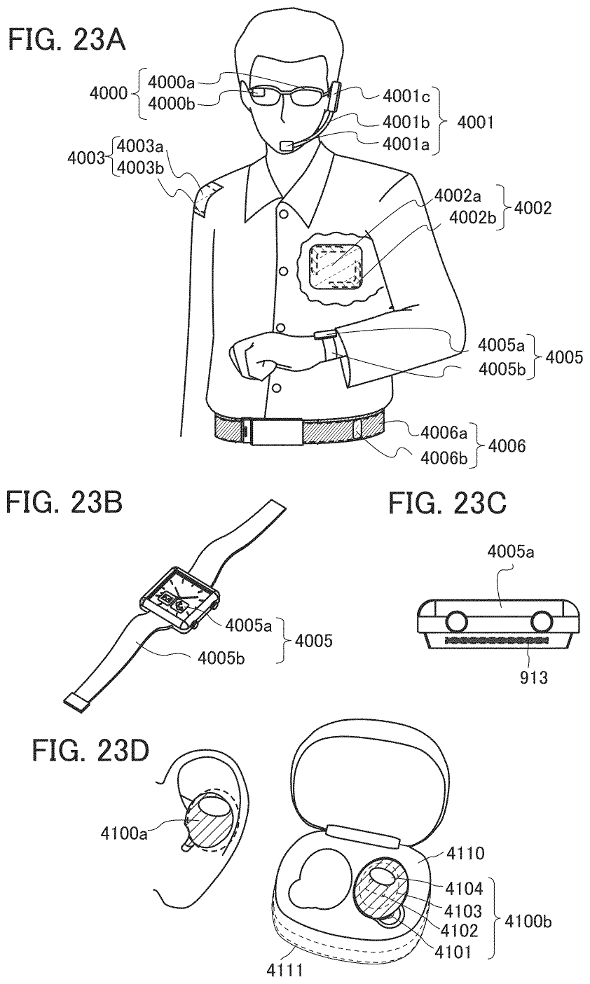

FIG. 23A illustrates examples of wearable devices. A secondary battery is used as a power source of a wearable device. To have improved splash resistance, water resistance, or dust resistance in daily use or outdoor use by a user, a wearable device is desirably capable of wireless charging as well as wired charging, for which a connector is exposed.

For example, the secondary battery of one embodiment of the present invention can be provided in a glasses-type device 4000 illustrated in FIG. 23A. The glasses-type device 4000 includes a frame 4000a and a display portion 4000b. The secondary battery is provided in a temple of the frame 4000a having a curved shape, whereby the glasses-type device 4000 can be lightweight, can have a well-balanced weight, and can be used continuously for a long time. A secondary battery including a positive electrode using the positive electrode active material 100 obtained in Embodiment 1 has a high energy density and achieves a structure that accommodates space saving due to a reduction in size of the housing.

The secondary battery of one embodiment of the present invention can be provided in a headset-type device 4001. The headset-type device 4001 includes at least a microphone part 4001a, a flexible pipe 4001b, and an earphone portion 4001c. The secondary battery can be provided in the flexible pipe 4001b or the earphone portion 4001c. A secondary battery including a positive electrode using the positive electrode active material 100 obtained in Embodiment 1 has a high energy density and achieves a structure that accommodates space saving due to a reduction in size of the housing.

The secondary battery of one embodiment of the present invention can be provided in a device 4002 that can be attached directly to a body. A secondary battery 4002b can be provided in a thin housing 4002a of the device 4002. A secondary battery including a positive electrode using the positive electrode active material 100 obtained in Embodiment 1 has a high energy density and achieves a structure that accommodates space saving due to a reduction in size of the housing.

The secondary battery of one embodiment of the present invention can be provided in a device 4003 that can be attached to clothes. A secondary battery 4003b can be provided in a thin housing 4003a of the device 4003. A secondary battery including a positive electrode using the positive electrode active material 100 obtained in Embodiment 1 has a high energy density and achieves a structure that accommodates space saving due to a reduction in size of the housing.

The secondary battery of one embodiment of the present invention can be provided in a belt-type device 4006. The belt-type device 4006 includes a belt portion 4006a and a wireless power feeding and receiving portion 4006b, and the secondary battery can be provided in the inner region of the belt portion 4006a. A secondary battery including a positive electrode using the positive electrode active material 100 obtained in Embodiment 1 has a high energy density and achieves a structure that accommodates space saving due to a reduction in size of the housing.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. A secondary battery including a positive electrode using the positive electrode active material 100 obtained in Embodiment 1 has a high energy density and achieves a structure that accommodates space saving due to a reduction in size of the housing.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 23B is a perspective view of the watch-type device 4005 that is detached from an arm.

FIG. 23C is a side view of the watch-type device 4005. FIG. 23C illustrates a state where the secondary battery 913 is incorporated in the inner region. The secondary battery 913 is the secondary battery described in Embodiment 4. The secondary battery 913 is provided to overlap the display portion 4005a, can have a high density and high capacity, and is small and lightweight.

Since the secondary battery in the watch-type device 4005 is required to be small and lightweight, the use of the positive electrode active material 100 obtained in Embodiment 1 in the positive electrode enables the secondary battery 913 to have a high energy density and a small size.

FIG. 23D illustrates an example of wireless earphones. Here, the wireless earphones including a pair of main bodies 4100a and 4100b are shown as an example; however, a pair of main bodies are not always necessary.

Each of the main bodies 4100a and 4100b includes a driver unit 4101, an antenna 4102, and a secondary battery 4103. Each of the main bodies 4100a and 4100b may also include a display portion 4104. Moreover, each of the main bodies 4100a and 4100b preferably includes a substrate where a circuit such as a wireless IC is provided, a terminal for charging, and the like. Each of the main bodies 4100a and 4100b may also include a microphone.

A case 4110 includes a secondary battery 4111. Moreover, the case 4110 preferably include a substrate where a circuit such as a wireless IC or a charge control IC is provided, and a terminal for charging. The case 4110 may also include a display portion, a button, and the like.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to and played through the main body 4100a and 4100b. Hence, the wireless earphones can be used as a translator, for example.

The secondary battery 4103 included in the main body 4100a can be charged by the secondary battery 4111 included in the case 4100. As the secondary battery 4111 and the secondary battery 4103, the coin-type secondary battery or the cylindrical secondary battery of the foregoing embodiment, for example, can be used. A secondary battery including a positive electrode using the positive electrode active material 100 obtained in Embodiment 1 has a high energy density; thus, using the secondary battery as the secondary battery 4111 and the secondary battery 4103 can achieve a structure that accommodates space saving due to a reduction in size of the wireless earphones.

This embodiment can be combined with any of the other embodiments as appropriate.

### Example

In this example, positive electrode active materials were manufactured by the manufacturing method of one embodiment of the present invention, and their charge and discharge cycle performance was compared to that of a comparative positive electrode active material.

### <Manufacture of Positive Electrode Active Material>

Samples manufactured in this example will be described with reference to the manufacturing method shown in FIG. 2.

### <Sample 1>

First, as the composite oxide 832 containing the additive element X in Step S61, lithium nickel-cobalt-manganese oxide (EQ-Lib-LNCM811 made by MTI Corporation) was prepared. This material contains nickel, cobalt, and manganese as the transition metals M and includes nickel of 47.50±1.50 wt %, manganese of 5.50±0.60 wt %, and cobalt of 6.60±0.60 wt %. Moreover, the material includes iron of 0.004 wt % or less, generally approximately 0.0016 wt % as the additive element X.

Furthermore, calcium carbonate was prepared as the additive element X source d in Step S62.

Next, calcium carbonate was weighed to be 0.5 mol % with respect to lithium nickel-cobalt-manganese oxide, and they were mixed by a dry method. The mixing was performed in a ball mill using zirconia balls with a diameter of 1 nm as media at 150 rpm for one hour. The mixture was passed through a separation sieve with a mesh size of 300 μm, thereby obtaining the mixture 841.

Then, in Step S74, the mixture 841 of lithium nickel-cobalt-manganese oxide and calcium carbonate was heated. The mixture 841 was put in an alumina crucible, the lid is put on the crucible, and heating was performed with a muffle furnace at 800° C. for two hours. The oxygen flow rate was 5 L/min, and the temperature rising rate was 200° C./hour. After that, the heated materials were cooled to room temperature. The temperature decreasing time from 800° C. to room temperature was 10 hours or longer.

The heated materials were passed through a sieve with a mesh size of 53 μm to give the positive electrode active material. This was referred to as Sample 1.

### <Sample 2>

Sample 2 was fabricated in the same manner as Sample 1 except that calcium fluoride was used as the additive element X source d.

### <Sample 3>

Sample 3 was fabricated in the same manner as Sample 1 except that calcium chloride was used as the additive element X source d.

### <Sample 4>

Sample 4 was fabricated in the same manner as Sample 1 except that lithium fluoride was used as the additive element X source d, and that lithium fluoride was mixed to be 1 mol % with respect to lithium nickel-cobalt-manganese oxide.

### <Sample 5>

Sample 5 was fabricated in the same manner as Sample 1 except that lithium fluoride and lithium carbonate were used as the additive element X sources d, and that lithium fluoride and lithium carbonate were both mixed to be 0.5 mol % with respect to lithium nickel-cobalt-manganese oxide.

### <Sample 6>

Sample 6 was fabricated in the same manner as Sample 5 except that the heating temperature was 700° C.

### <Sample 7>

Sample 7 was fabricated in the same manner as Sample 5 except that the heating temperature was 900° C.

### <Sample 8>

Sample 8 was fabricated in the same manner as Sample 1 except that lithium fluoride and sodium fluoride were used as the additive element X sources d, and that lithium fluoride and sodium fluoride were both mixed to be 0.5 mol % with respect to lithium nickel-cobalt-manganese oxide.

### <Sample 9>

Sample 9 was fabricated in the same manner as Sample 1 except that lithium fluoride and calcium fluoride were used as the additive element X sources d, and that lithium fluoride and calcium fluoride were both mixed to be 0.5 mol % with respect to lithium nickel-cobalt-manganese oxide.

### <Sample 10>

Sample 10 was fabricated in the same manner as Sample 9 except that the heating time was 20 hours.

### <Sample 11>

Sample 11 was fabricated in the same manner as Sample 9 except that the heating time was 60 hours.

### <Sample 12>

Sample 12 was fabricated in the same manner as Sample 9 except that the heating temperature was 700° C.

### <Sample 13>

Sample 13 was fabricated in the same manner as Sample 9 except that the heating temperature was 900° C.

### <Sample 14>

Sample 14 was fabricated in the same manner as Sample 1 except that lithium fluoride and aluminum fluoride were used as the additive element X sources d, and that lithium fluoride and aluminum fluoride were mixed to be 0.89 mol % and 0.5 mol %, respectively, with respect to lithium nickel-cobalt-manganese oxide.

### <Sample 15>

Sample 15 was fabricated in the same manner as Sample 14 except that the heating time was 20 hours.

### <Sample 16>

Sample 16 was fabricated in the same manner as Sample 1 except that lithium fluoride and lithium titanate were used as the additive element X sources d, that lithium fluoride and lithium titanate were mixed to be 0.89 mol % and 0.13 mol %, respectively, with respect to lithium nickel-cobalt-manganese oxide, and that the heating time was 20 hours.

### <Sample 17>

Sample 17 was fabricated in the same manner as Sample 1 except that lithium fluoride and magnesium fluoride were used as the additive element X sources d, that lithium fluoride and magnesium fluoride were both mixed to be 0.5 mol % with respect to lithium nickel-cobalt-manganese oxide, and that the heating time was 20 hours.

### <Sample 20>

Sample 20 (comparative example) was lithium nickel-cobalt-manganese oxide without addition of the additive element X source d or heating. This is sometimes referred to as Unprocessed Sample.

### <Sample 21>

Sample 21 was lithium nickel-cobalt-manganese oxide heated at 800° C. for two hours without addition of the additive element X source d.

Table 1 shows the fabrication conditions of Samples 1 to 21.

TABLE 1

| | Additive | Heating conditions |
|---|---|---|
| | (mol % with respect to NCM) | (° C., hr) |
| Sample 1 | CaCO₃ (0.5) | 800, 2 |
| Sample 2 | CaF₂ (0.5) | 800, 2 |
| Sample 3 | CaCl₂ (0.5) | 800, 2 |
| Sample 4 | LiF (1) | 800, 2 |
| Sample 5 | LiF (0.5), Li₂CO₃ (0.5) | 800, 2 |
| Sample 6 | LiF (0.5), Li₂CO₃ (0.5) | 700, 2 |
| Sample 7 | LiF (0.5), Li₂CO₃ (0.5) | 900, 2 |
| Sample 8 | LiF (0.5), NaF (0.5) | 800, 2 |
| Sample 9 | LiF (0.5), CaF₂ (0.5) | 800, 2 |
| Sample 10 | LiF (0.5), CaF₂ (0.5) | 800, 20 |
| Sample 11 | LiF (0.5), CaF₂ (0.5) | 800, 60 |
| Sample 12 | LiF (0.5), CaF₂ (0.5) | 700, 2 |
| Sample 13 | LiF (0.5), CaF₂ (0.5) | 900, 2 |
| Sample 14 | LiF (0.89), AlF₃ (0.5) | 800, 2 |
| Sample 15 | LiF (0.89), AlF₃ (0.5) | 800, 20 |
| Sample 16 | LiF (0.89), Li₂TiO₃ (0.13) | 800, 20 |
| Sample 17 | LiF (0.5), MgF₂ (0.5) | 800, 20 |
| Sample 20 | — | — |
| Sample 21 | — | 800, 2 |

### <Cycle Performance>

Next, secondary batteries were fabricated using Samples 1 to 21, and their cycle performance was evaluated.

First, each positive electrode active material, acetylene black (AB), and PVDF were mixed at a weight ratio of 95:3:2 to form slurries, and the slurries were applied to aluminum current collectors. As a solvent of the slurries, NMP was used.

After the current collectors were coated with the slurries, the solvent was volatilized. Through the above steps, the positive electrodes were obtained. The loading amount of the active material in the positive electrode was approximately 7 mg/cm², and the density thereof was 3.4 g/cc or higher.

CR2032 coin-type battery cells (diameter: 20 mm, height: 3.2 mm) were fabricated with the use of the formed positive electrodes.

A lithium metal was used for a counter electrode.

As an electrolyte contained in an electrolyte solution, 1 mol/L lithium hexafluorophosphate (LiPF₆) was used. As the electrolyte solution, a solution in which 2 wt % vinylene carbonate (VC) was added, as the additive agent, to a mixture of ethylene carbonate (EC) and diethyl carbonate (DEC) at a volume ratio of 3:7 was used.

As a separator, 25-μm-thick polypropylene was used.

A positive electrode can and a negative electrode can that were formed of stainless steel (SUS) were used.

A cycle test was performed under the following conditions. The charging voltage was 4.4 V. The measurement environment temperatures were 45° C., 25° C., and −20° C. CC/CV charging (0.5 C, 0.05 C cut) and CC discharging (0.5 C, 2.5 V cut) were performed, and a 10-minute break was taken before the next charging. Note that 1 C was set to 200 mA/g in this example and the like.

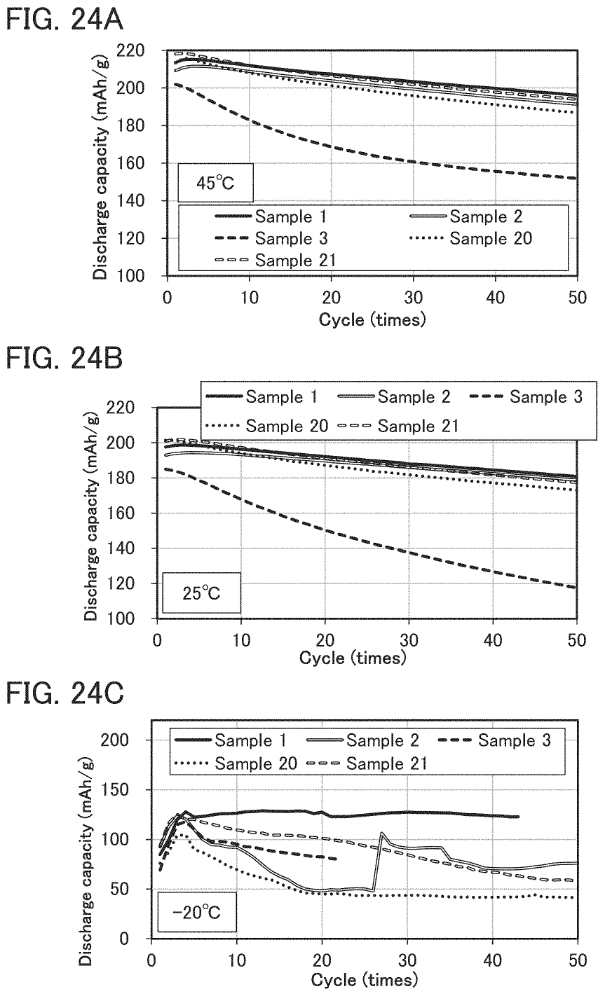

FIG. 24A shows the results of the charge and discharge cycle test on Samples 1 to 3, Sample 20, and Sample 21 at 45° C. FIG. 24B shows the results at 25° C. FIG. 24C shows the results at −20° C.

At 45° C. and 25° C., the discharge capacity of Sample 3, to which calcium fluoride was added, was lower than that of the other samples. Sample 1, Sample 2, Sample 20, and Sample 21 showed good charge and discharge cycle performance, among which Sample 1, Sample 2, and Sample 21, which were subjected to heating, exhibited better performance. In particular, Sample 1, to which calcium carbonate was added, and Sample 2, to which calcium fluoride was added, exhibited favorable performance.

Meanwhile, at −20° C., although a change in discharge capacity was unstable, the samples other than Unprocessed Sample 20 showed good charge and discharge cycle performance, and Sample 1, to which calcium carbonate was added, exhibited the best performance.

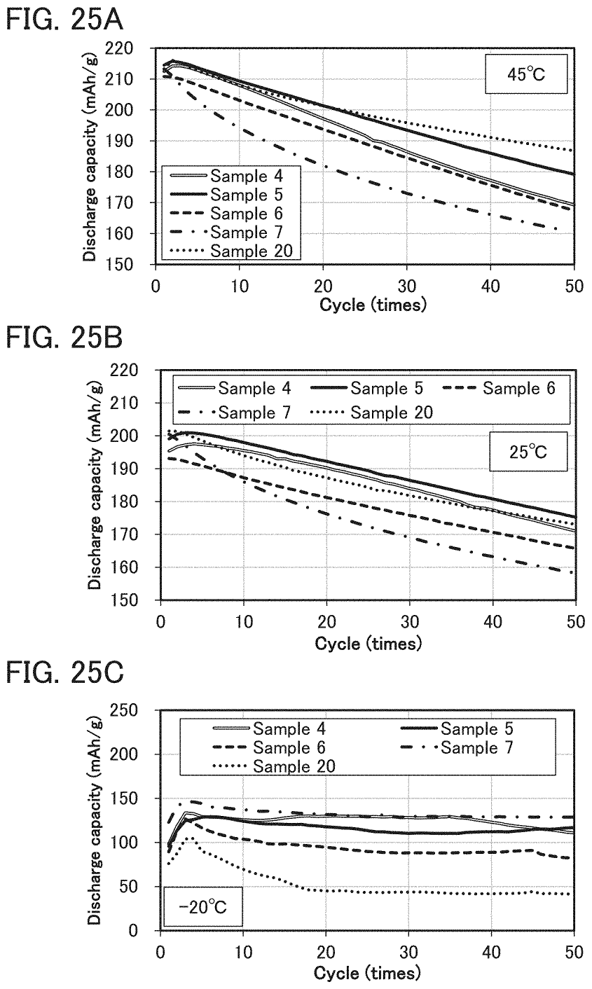

FIG. 25A shows the results of the charge and discharge cycle test on Samples 4 to 7 and Sample 20 at 45° C. FIG. 25B shows the results at 25° C. FIG. 25C shows the results at −20° C.

At 45° C., Unprocessed Sample 20 showed the best charge and discharge cycle performance. At 25° C., Sample 5, to which lithium fluoride and lithium carbonate were added, exhibited the best performance. At −20° C., Samples 4 to 7 exhibited better performance than Unprocessed Sample 20.

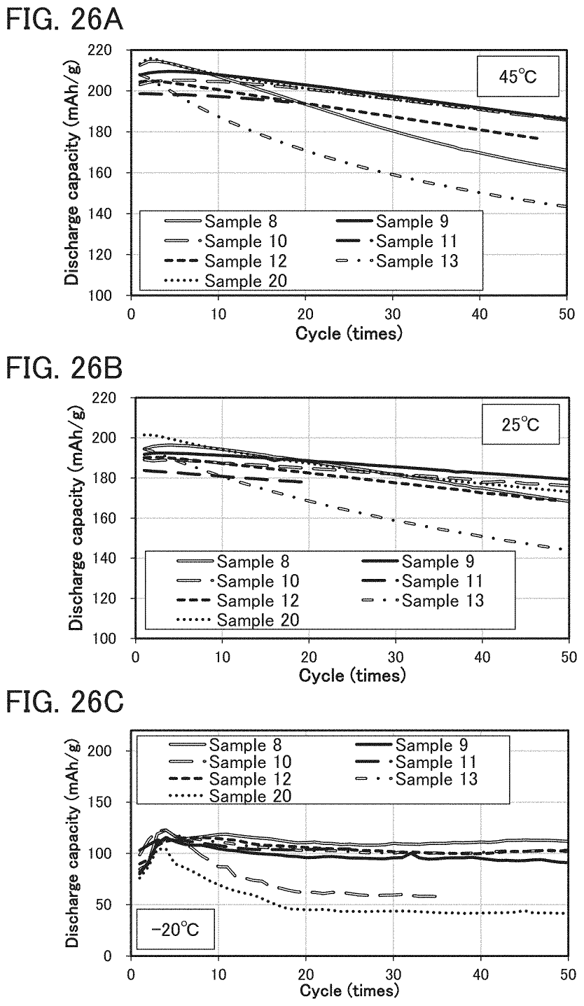

FIG. 26A shows the results of the charge and discharge cycle test on Samples 8 to 13 and Sample 20 at 45° C. FIG. 26B shows the results at 25° C. FIG. 26C shows the results at −20° C.

At 45° C., Sample 9, Sample 10, and Unprocessed Sample 20 showed almost the same charge and discharge cycle performance. In Sample 8, to which sodium fluoride was added, the initial capacity was high, but a decrease in capacity over charge and discharge cycles was comparatively large. At 25° C., Sample 9 and Sample 10, to which lithium fluoride and calcium fluoride were added, clearly showed better charge and discharge cycle performance than Sample 20.

Meanwhile, at −20° C., Samples 8 to 13 exhibited better performance than Unprocessed Sample 20.

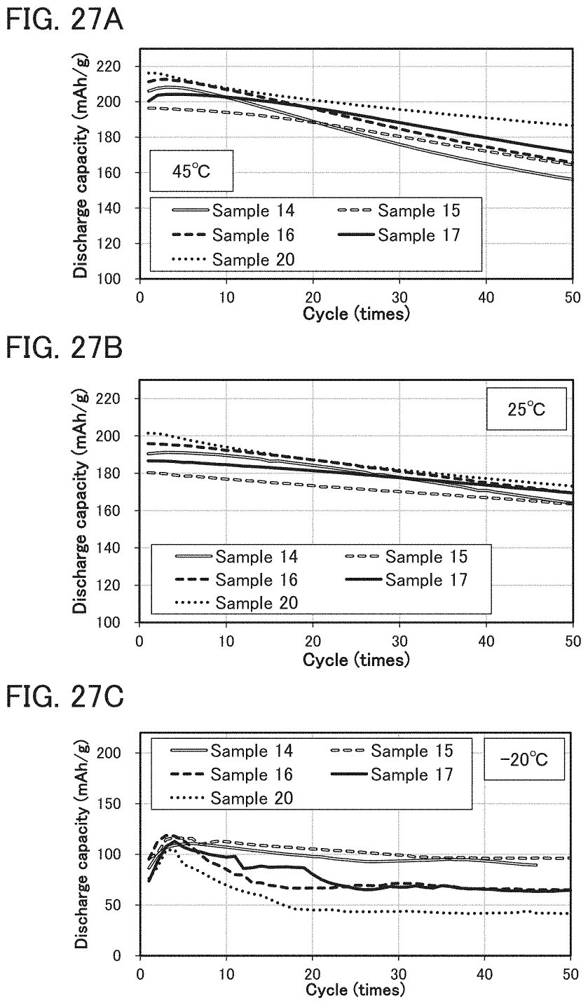

FIG. 27A shows the results of the charge and discharge cycle test on Samples 14 to 17 and Sample 20 at 45° C. FIG. 27B shows the results at 25° C. FIG. 27C shows the results at −20° C.

At 45° C. and 25° C., Unprocessed Sample 20 showed the best charge and discharge cycle performance. On the other hand, at −20° C., Samples 14 to 17 exhibited better performance than Unprocessed Sample 20.

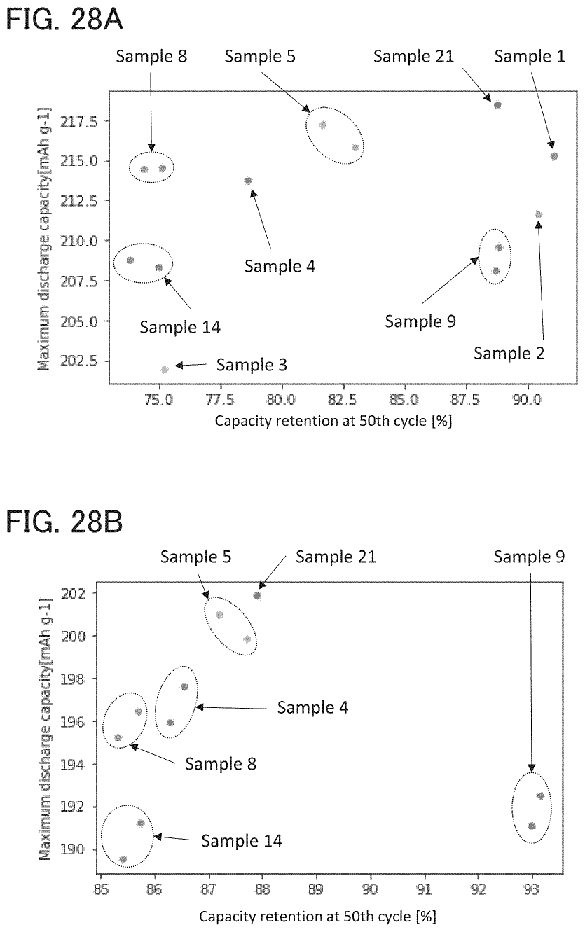

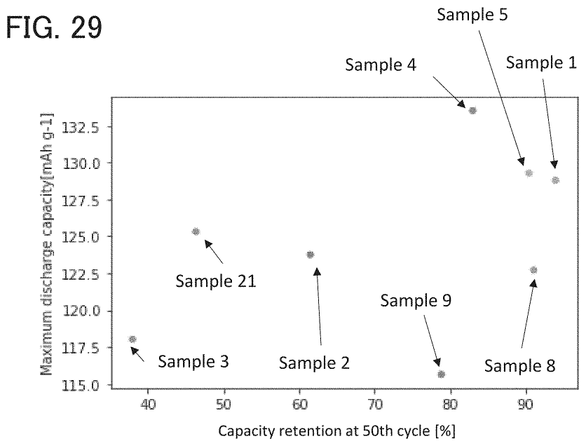

Regarding the charge and discharge cycle performance of Samples 1 to 4, Sample 8, Sample 9, Sample 14, and Sample 21, which were subjected to heating at 800° C. for two hours, FIGS. 28A and 28B and FIG. 29 are graphs showing the discharge capacity retention rate at the 50th cycle and maximum discharge capacity. The position closer to the upper right corner of the graph indicates a favorable positive electrode active material having higher charge and discharge cycle performance and higher discharge capacity.

FIG. 28A shows the graph at 45° C. It was demonstrated that Sample 1, to which calcium carbonate was added, Sample 2, to which calcium fluoride was added, and Sample 21, which was subjected to heating without addition of the additive element X source d, for example, showed favorable charge and discharge cycle performance.

FIG. 28B shows the graph at 25° C. It was demonstrated that Sample 9, to which lithium fluoride and calcium fluoride were added, showed favorable charge and discharge cycle performance.

FIG. 29 shows the graph at −20° C. It was demonstrated that Sample 1, to which calcium carbonate was added, Sample 5, to which lithium fluoride and lithium carbonate were added, Sample 8, to which lithium fluoride and sodium fluoride were added, and Sample 4, to which lithium fluoride was added, showed favorable charge and discharge cycle performance.

Next, a charge and discharge cycle test was performed on Samples 1 to 3 and Sample 20 with a charging voltage of 4.5 V. The measurement environment temperatures were 45° C. and 25° C. CC/CV charging (0.5 C, 0.05 C cut) and CC discharging (0.5 C, 2.5 V cut) were performed, and a 10-minute break was taken before the next charging.

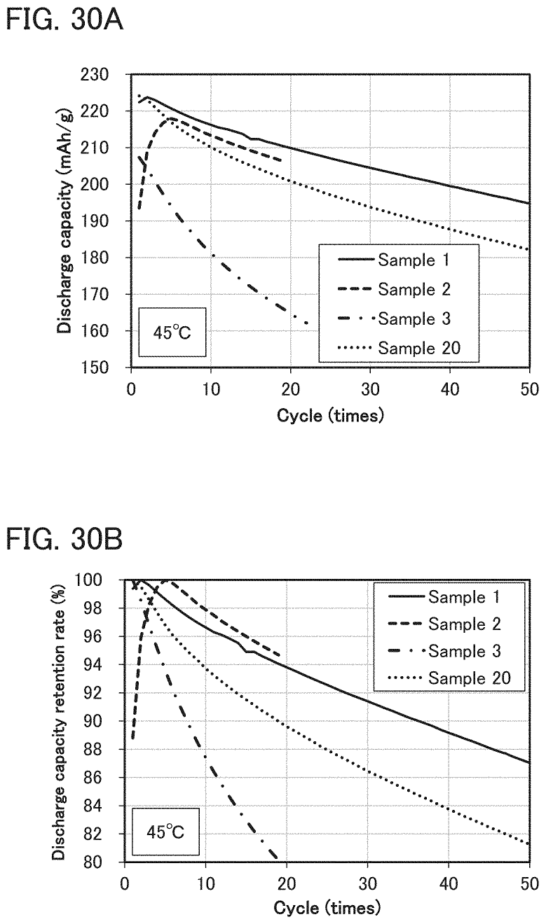

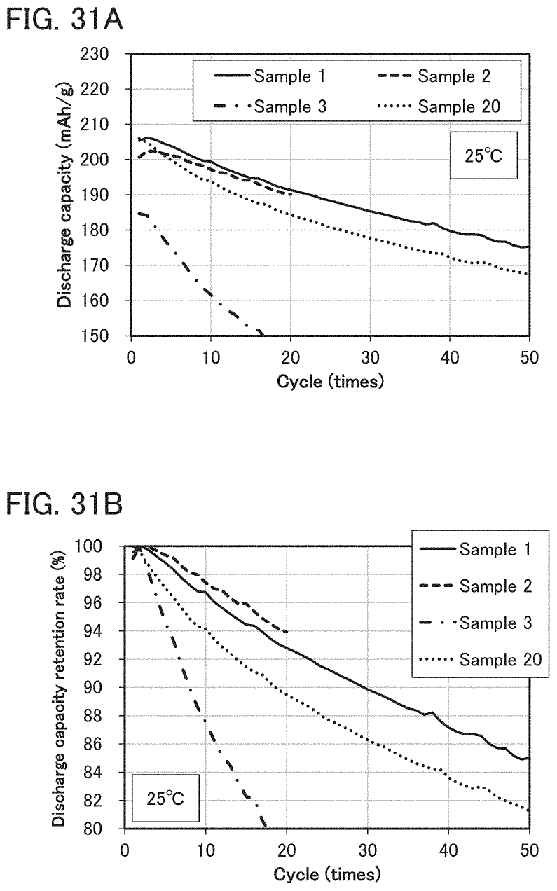

FIG. 30A is a graph showing discharge capacity at 45° C., and FIG. 30B is a graph showing a discharge capacity retention rate at 45° C. FIG. 31A is a graph showing discharge capacity at 25° C., and FIG. 31B is a graph showing a discharge capacity retention rate at 25° C.

As in the case of a charging voltage of 4.4 V, the discharge capacity of Sample 3, to which calcium fluoride was added, was lower than that of the other samples.

Sample 1, to which calcium carbonate was added, and Sample 2, to which calcium fluoride was added, showed better charge and discharge cycle performance than Unprocessed Sample 20. Although Sample 2 had a slightly higher discharge capacity retention rate, Sample 1 had higher discharge capacity and showed more preferable characteristics.

This application is based on Japanese Patent Application Serial No. 2020-150780 filed with Japan Patent Office on Sep. 8, 2020, the entire contents of which are hereby incorporated by reference.

1. A method for manufacturing a secondary battery, comprising:
forming a composite oxide comprising lithium, nickel, manganese, cobalt, and oxygen; and
mixing the composite oxide and a calcium compound, and then performing heating at a temperature higher than or equal to 500° C. and lower than or equal to 1100° C. for a time longer than or equal to 2 hours and shorter than or equal to 20 hours.

2. The method for manufacturing a secondary battery, according to claim 1,
wherein the calcium compound is calcium carbonate or calcium fluoride.

3. The method for manufacturing a secondary battery, according to claim 1,
wherein when a sum of the number of atoms of the nickel, the manganese, and the cobalt included in the composite oxide is 100, the number of atoms of the nickel is greater than or equal to 50.

4. A secondary battery comprising a positive electrode,
wherein the positive electrode comprises a positive electrode active material,
wherein the positive electrode active material comprises lithium, nickel, manganese, cobalt, oxygen, and an additive element,
wherein the additive element is one or more selected from calcium, fluorine, sodium, iron, arsenic, sulfur, and copper,
wherein the positive electrode active material comprises a surface portion and an inner portion, and
wherein a concentration of one or more selected from the additive element(s) is higher in the surface portion than in the inner portion.

5. The secondary battery according to claim 4,
wherein the positive electrode active material comprises a plurality of primary particles and a secondary particle in which the plurality of primary particles adhere to each other, and
wherein a concentration of one or more selected from the additive element(s) is higher in a surface portion of the primary particles than in an inner portion.

6. The secondary battery according to claim wherein the additive element is calcium or fluorine.

7. A secondary battery comprising a positive electrode,
wherein the positive electrode comprises a positive electrode active material,
wherein the positive electrode active material comprises a first region and a second region covering at least part of the first region,
wherein the positive electrode active material comprises lithium, nickel, manganese, cobalt, oxygen, and calcium,
wherein when a sum of the number of atoms of the nickel, the manganese, and the cobalt included in the positive electrode active material is 100, the number of atoms of the nickel is greater than or equal to 80, and
wherein a concentration of the calcium is higher in the second region than in the first region.

8. The secondary battery according to claim 7,
wherein the positive electrode active material further comprises fluorine, and
wherein a concentration of the fluorine is higher in the second region than in the first region.

9. The secondary battery according to claim 7,
wherein the positive electrode active material further comprises iron,
wherein a concentration of the iron is higher in the second region than in the first region.

10. The secondary battery according to claim 7,
wherein the positive electrode active material is a primary particle, and
wherein the positive electrode active material comprises a secondary particle which comprises a plurality of primary particles.

11. The method for manufacturing a secondary battery, according to claim 2,
wherein when a sum of the number of atoms of the nickel, the manganese, and the cobalt included in the composite oxide is 100, the number of atoms of the nickel is greater than or equal to 50.

12. The secondary battery according to claim 5,
wherein the additive element is calcium or fluorine.
